(19) United States
(12) Patent Application Publication
(10) Pub. No.: US 2026/0311472 A1
(43) Pub. Date: Oct. 8, 2026

(54) SURFACE FEATURE DETECTION FROM POINT CLOUDS FOR AUTONOMOUS AND SEMI-AUTONOMOUS SYSTEMS AND APPLICATIONS

(71) Applicant: NVIDIA CORPORATION, Santa Clara, CA (US)

(72) Inventors: Jens Christian Bo Joergensen, Flushing, NY (US); Elad Plaut, Santa Clara, CA (US); Joachim Pehserl, Lynnwood, WA (US)

(21) Appl. No.: 19/203,467

(22) Filed: May 9, 2025

Related U.S. Application Data
(60) Provisional application No. 63/765,553, filed on Mar. 1, 2025.

(51) Int. Cl. G06V 10/82; G06V 10/75; G06V 10/764

(52) U.S. Cl. CPC G06V 10/82; G06V 10/754; G06V 10/764

(57) ABSTRACT

In various examples, surface features such as lane lines or road boundaries may be detected and 2D or 3D polylines representing their shape may be regressed. For example, a set of predefined vertical, slanted, and/or curved anchors may be used to represent corresponding lines (e.g., in a top-down view or bird's eye view). For each anchor, extracted features may be sampled along the anchor and processed using one or more DNNs to generate global (e.g., anchor-level) predictions such as an anchor-level existence or confidence score and/or local (e.g., per-point) predictions for each of a set of sampled points along the anchor such as regressed polylines and per-point classifications. The detected surface features may be used by one or more control components such as a drive or control stack for localization, safe planning, and control of an autonomous vehicle, semi-autonomous vehicle, machine, robot, and/or other object or machine type.

### CROSS-REFERENCE TO RELATED APPLICATIONS

This application claims the benefit of U.S. Provisional Application No. 63/765,553, filed on Mar. 1, 2025, the contents of which are hereby incorporated by reference in their entirety.

### BACKGROUND

Perception of surface (e.g., road, navigable path) elements or features-such as lane lines, road boundaries, intersection boundaries, and warehouse floor markings-often plays a significant role in autonomous and semi-autonomous machine control operations. These surface features can provide visual cues for motion or path planning algorithms to perform functions like path planning, lane keeping, and decision-making. Without reliable lane or surface feature detection, autonomous and semi-autonomous machines can become unpredictable or unsafe, especially in complex environments like intersections, construction zones, busy warehouses, or bad weather.

Existing techniques generally rely on deep neural networks (DNNs) to detect surface markings (e.g., lane lines) as polylines and typically fall into one of three primary categories: anchor-based detectors, anchor-free detectors, and query-based detectors. Anchor-based lane detectors typically predict the locations of lane lines relative to a fixed set of predefined anchors (e.g., points or lines) across an image. Anchor-free lane detectors directly predict lane lines locations without relying on predefined anchors. Query-based detectors use learnable transformer queries instead of using fixed anchor positions, allowing the DNN to learn where to look for lane lines based on context.

However, existing techniques for lane line detection have a variety of drawbacks. For example, anchor-free detectors typically predict a straight line (e.g., represented using orientation angle, radial offset from the cell center, and elevation above ground) for each bird's-eye view (BEV) grid cell. To group these predictions into coherent lane instances, existing techniques rely on an additional learned embedding space in which similar predictions are clustered using techniques like mean-shift. However, this instance association step requires non-trivial heuristics and post-processing, which increase computational overhead and introduce potential sources of error—especially in scenarios involving closely spaced or interacting (e.g., splitting and merging) lanes.

Query-based detectors leverage transformer-based architectures in which each learnable query corresponds to a potential map element, typically represented by a set of key-points serving as an intermediate representation. These key-points guide a polyline generator—often implemented as an autoregressive transformer decoder—that sequentially predicts the polyline's nodes and structure. However, existing query-based detectors are computationally intensive, require complex network design and substantial training data, and are not universally supported by real-time inference platforms. As a result, these systems often experience increased latency and deployment challenges in real-time or near real-time implementations.

Anchor-based lane detectors typically use vertical line anchors, where each anchor corresponds to a fixed vertical (longitudinal) line in the BEV grid, and a DNN predicts lateral offsets at fixed vertical intervals to construct polylines representing lane markings. During training, each ground-truth lane is associated with the closest anchor based on the smallest lateral distance at a predefined reference point along the vertical axis. However, this design introduces several limitations. Because predictions for all points along an anchor are derived from the same local features, the DNN must implicitly encode spatial location, which can result in limited accuracy. The use of vertical anchors also makes it difficult to accurately capture lanes with significant curvature or slant. Furthermore, assigning ground-truth lanes to anchors based on proximity to a single reference point limits the DNN's ability to represent complex geometries such as merges or splits that occur farther away from that reference point. Moreover, existing techniques typically predict a full-lane polyline extending across the field of view and assign a single confidence score to the entire lane, even if the lane begins or ends somewhere within the input scene, reducing the granularity and reliability of the confidence estimation. All of these drawbacks effectively limit the ability to safely navigate an autonomous or semi-autonomous machine though the environment.

As a result, there is a need for improved surface feature detection techniques.

### SUMMARY

Embodiments of the present disclosure relate to surface feature detection from point clouds for autonomous and semi-autonomous systems and applications. Systems and methods are disclosed that implement an anchor-based technique to detect surface markings and other surface (e.g., road, navigational) elements or features (e.g., lane lines, road boundaries, intersection boundaries, warehouse floor markings).

In contrast to conventional systems, the systems and methods of the present disclosure may use a set of predefined vertical, slanted, and/or curved anchors representing corresponding lines (e.g., in a top-down view or bird's eye view). For each anchor, extracted features may be sampled along the anchor and processed using one or more DNNs to generate global (e.g., anchor-level) predictions such as an anchor-level existence or confidence score and/or local (e.g., per-point) predictions for each of a set of sampled points along the anchor. Example per-point predictions may include regressed offset of the center of a detected surface feature relative to the anchor at each point, width of the detected surface feature at each point, elevation of each point, visibility of each point, uncertainty of one or more of the foregoing regressed values, and/or one or more classifications of each point into any number of supported classes. Examples of possible supported classes include surface markings (e.g., solid lane lines, dashed lane lines, double lane lines, warehouse floor markings, road boundary lines, intersection lines, etc.), other surface (e.g., road, navigational) elements or features (e.g., road boundaries, intersection boundaries, warehouse markings), landmarks (e.g., traffic lights, traffic signs, informational signs, poles), sub-classes of one or more of the foregoing (e.g., a left or right rail of a particular class of lane line, etc.), and/or otherwise. In some embodiments, a subsequent stage may be used to make refined predictions from features sampled at offsets predicted by an initial stage. Ground truth surface features (e.g., lane lines, warehouse path lines) may be converted to a corresponding center lane and widths, resampled at the designated vertical interval, and assigned to corresponding anchors with the smallest summed horizontal distance between the centerline and the anchor at each of the sampling points.

As such, the techniques described herein may be used to detect, classify, regress, and/or decode the shape of one or more surface features, and the detected surface features may be used by one or more control components such as a drive or control stack for localization, safe planning, and control of an autonomous vehicle, semi-autonomous vehicle, machine, robot, and/or other object or machine type.

### BRIEF DESCRIPTION OF THE DRAWINGS

The present systems and methods for surface feature detection from point clouds for autonomous and semi-autonomous systems and applications are described in detail below with reference to the attached drawing figures, wherein:

FIG. 1 is a data flow diagram illustrating an example surface feature detection system, in accordance with some embodiments of the present disclosure;

FIG. 2 is an example surface feature detection component, in accordance with some embodiments of the present disclosure;

FIG. 3 illustrates an example technique for assigning annotated surface features to a corresponding anchor, in accordance with some embodiments of the present disclosure;

FIGS. 4-6 illustrate example pairs of input data and corresponding detected surface features, in accordance with some embodiments of the present disclosure;

FIG. 7 is a flow diagram showing a method for generating at least one regressed line corresponding to at least one detected surface feature, in accordance with some embodiments of the present disclosure;

FIG. 8A is an example of sensor locations having corresponding fields of view or sensory fields for example autonomous or semi-autonomous machines, in accordance with at least some embodiments of the present disclosure;

FIG. 8B is an illustration of an example of component and sensor locations on an autonomous or semi-autonomous vehicle, in accordance with at least some embodiments of the present disclosure;

FIG. 8C is a block diagram of an example system architecture for an autonomous or semi-autonomous vehicle, robot, and/or other machine type, in accordance with at least some embodiments of the present disclosure;

FIG. 8D is a block diagram of an example architecture of a computing system—such as a system-on-a-chip (SoC)—in accordance with at least some embodiments of the present disclosure;

FIG. 8E is a system diagram for communication between cloud-based server(s) and an example autonomous or semi-autonomous vehicle, robot, and/or other machine type, in accordance with at least some embodiments of the present disclosure;

FIG. 9 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 10 is a block diagram of an example computing system for generative artificial intelligence (AI), in accordance with at least some embodiments of the present disclosure; and

FIG. 11 is a block diagram of an example computing device, in accordance with at least some embodiments of the present disclosure.

### DETAILED DESCRIPTION

Systems and methods are disclosed related to surface feature detection from point clouds for autonomous and semi-autonomous systems and applications. For example, systems and methods are disclosed that implement an anchor-based technique to detect surface markings and other surface (e.g., road, navigational) elements or features (e.g., lane lines, road boundaries, intersection boundaries), and the detected surface features may be used for localization, navigation, and/or other uses by autonomous or semi-autonomous machines such as self-driving vehicles, robots, drones, watercraft, aircraft, and/or other types of machines.

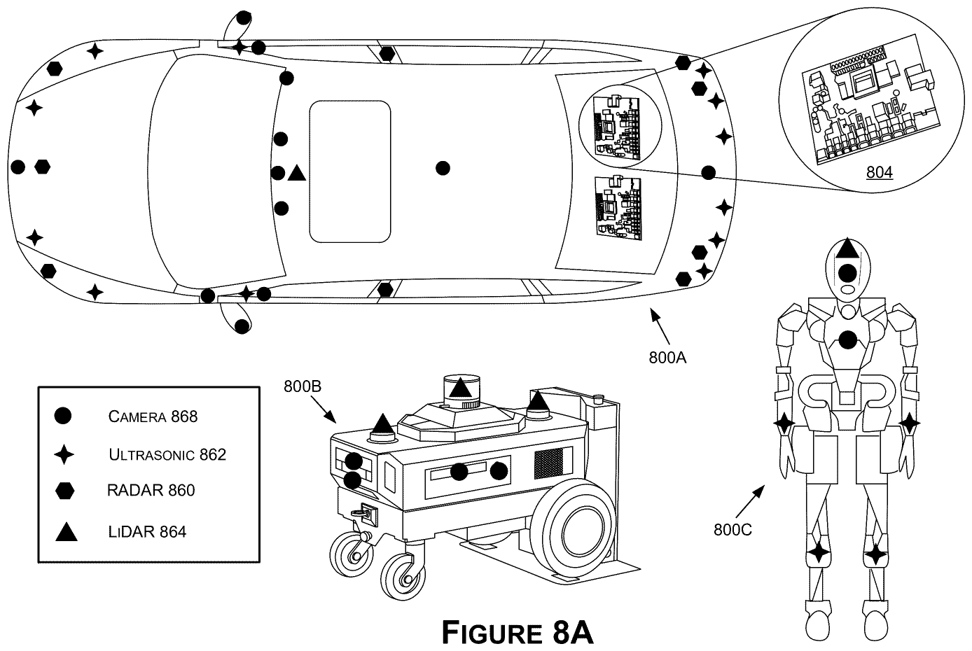

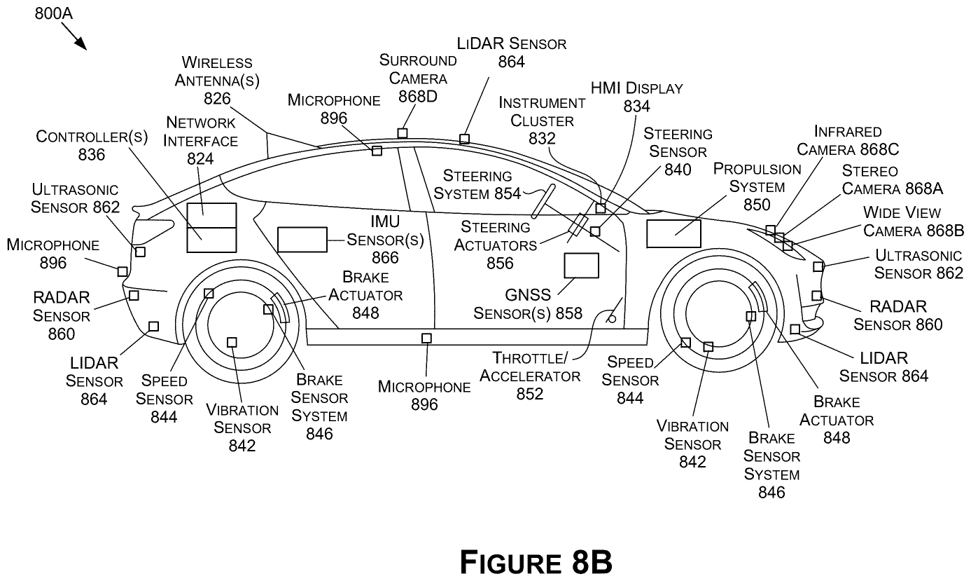

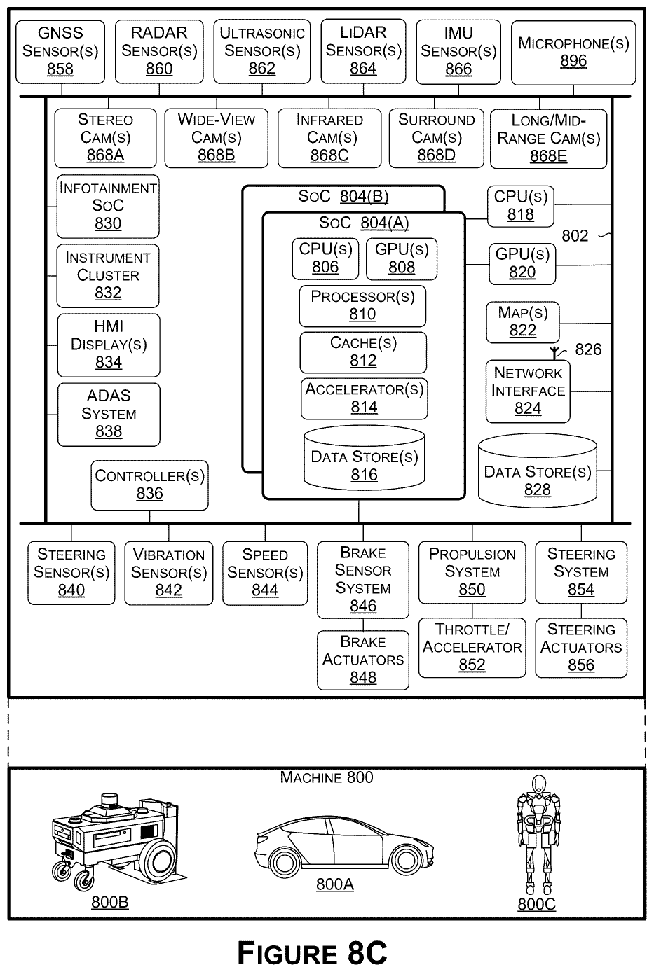

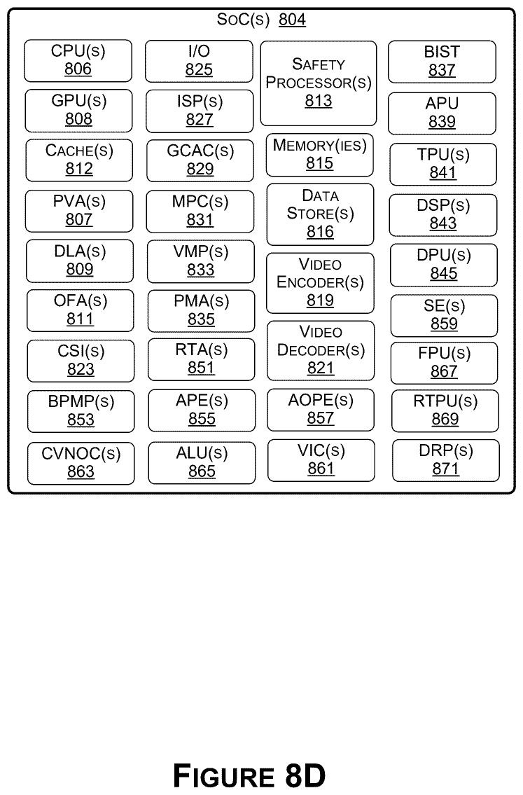

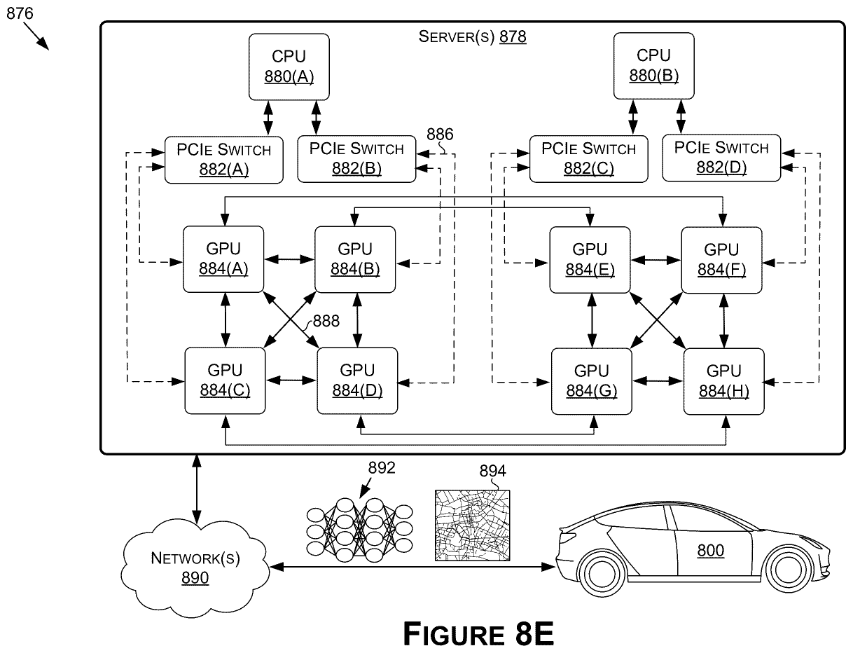

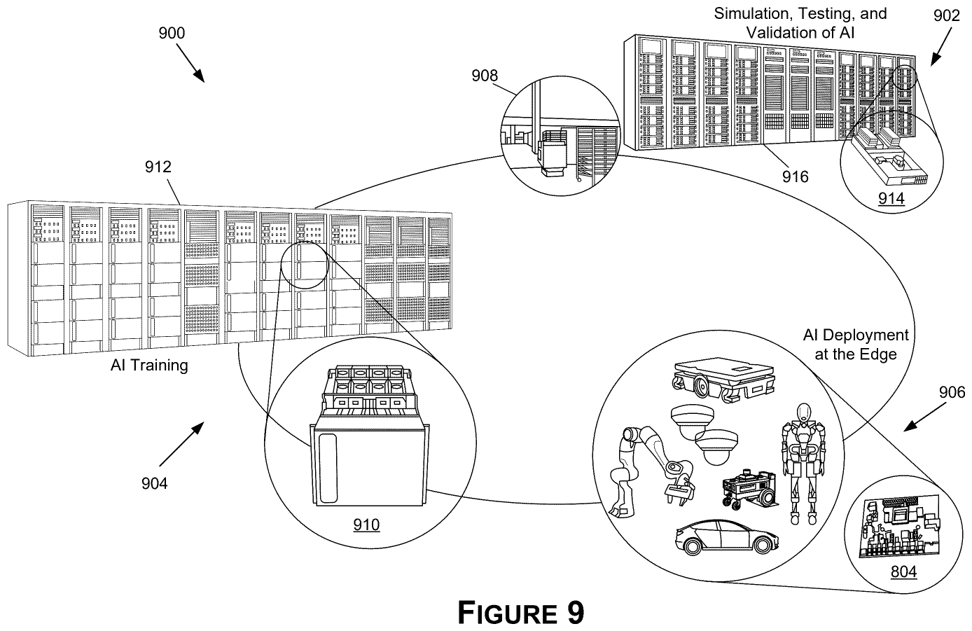

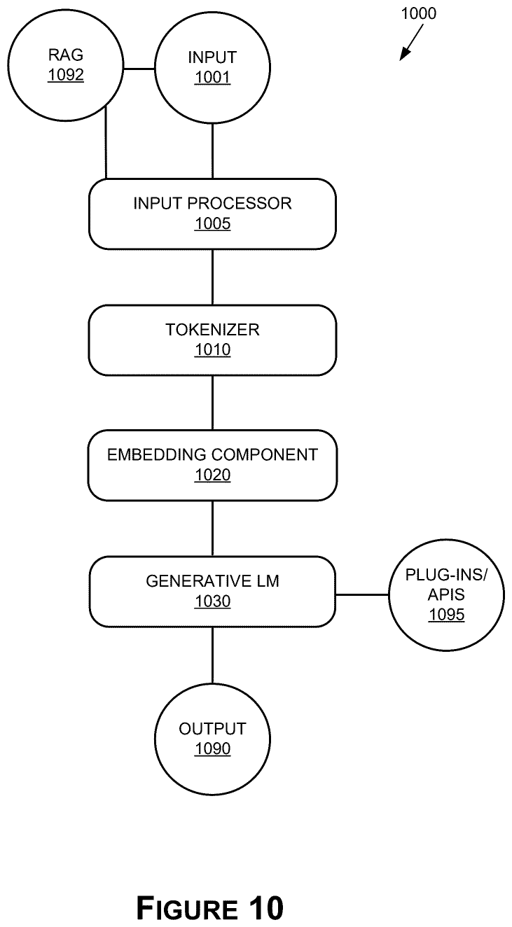

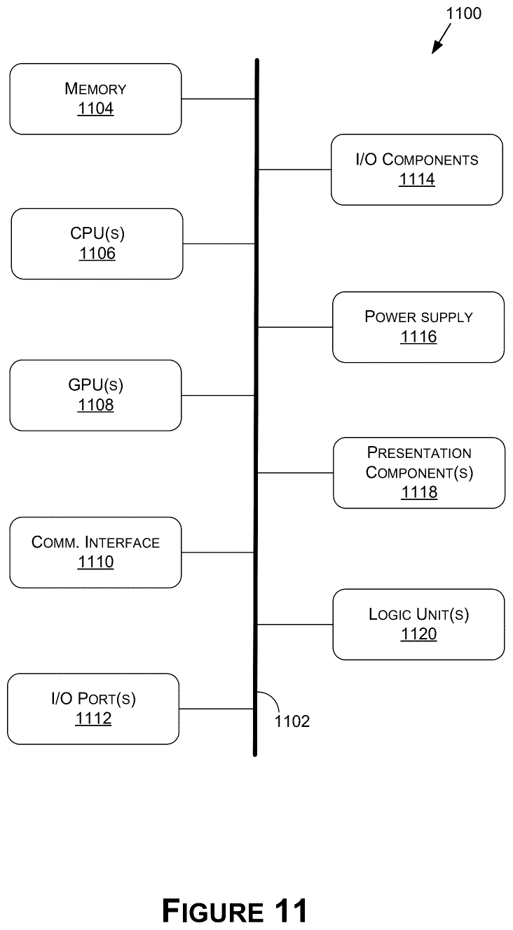

Although the present disclosure may be described with respect to an example autonomous or semi-autonomous vehicle, robot, and/or other machine type 800 (alternatively referred to herein as “vehicle 800,” “ego-vehicle 800,” “machine 800,” “ego-machine 800,” “robot 800,” and/or “ego-robot 800,” an example of which is described with respect to FIGS. 8A-8E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors), warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to lane line detection for autonomous driving, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where surface feature detection and/or localization or navigation based on detected surface features may be used. In some embodiments, the systems, methods, and/or processes described herein may be executed using similar components, features, and/or functionality to those of example machine 800 of FIGS. 8A-8E, example computing ecosystem 900 of FIG. 9, example generative language model system 1000 of FIG. 10, and/or example computing device 1100 of FIG. 11.

At a high level, one or more DNNs may use LiDAR data and/or other sensor data representing a three-dimensional (3D) environment to detect surface features such as lane lines and regress a representation of a curved or straight line corresponding to each detected surface feature. For example, one or more sensors (e.g., LiDAR sensors, RADAR sensors, cameras, etc.) of an ego-machine such as an autonomous or semi-autonomous vehicle may be used to generate sensor data (e.g., a 3D point cloud, which may be accumulated over any number of time slices). The sensor data may be formatted into a corresponding input representation (e.g., a projection image representing characteristics of measured 3D points, image(s) from any number of cameras, etc.), and the input representation may be applied to one or more DNNs to predict curved or straight lines relative to or otherwise associated with a set of predefined vertical, slanted, and/or curved anchors representing corresponding lines (e.g., in a top-down view or BEV). For each anchor, the DNN(s) may predict an anchor-level existence or confidence score, and for each of a set of predefined points along the anchor, one or more per-point predictions such as regressed offset from center, width, elevation, visibility, and uncertainty and/or classifications of each point into one or more supported classes (e.g., solid lane line, dashed lane line, double lane line, surface boundary, and/or sub-classes thereof such as left rail of a particular type of lane line or right rail of a particular type of lane line).

In some embodiments, the DNN(s) may extract a feature map, and for each anchor, a set of features may be sampled from the feature map along the anchor (at fixed points and/or using learned or deformable offsets), and the sampled features for each anchor may be applied through one or more shared processing layers of one or more output heads and/or output branches. These processing layers may be considered shared in the sense that the sampled features for some or all the anchors may be processed in separate anchor-wise passes through the same layers using shared weights. The local (per-point) features sampled from or around different points along the anchor and may be processed through corresponding paths independently of one another (e.g., they do not interact) in which case the paths may be considered disjoint or parallel branches, or the features may interact via operations such as convolution or self-attention in which case the paths may be considered interacting or coupled branches. Global (per-anchor) predictions may be generated by aggregating (e.g., using max or average pooling to combine) the local (e.g., per-point) features corresponding to the sampled points, and local (per-point) predictions may be made aware of global (per-anchor) features by aggregating (e.g., concatenating or adding) the local (e.g., per-point) features and the global (per-anchor) features. In some embodiments, a second stage may be used to make refined predictions from features sampled at offsets predicted by the first stage. Ground truth lane lines may be converted to a corresponding center lane and widths, resampled at the designated vertical interval, and assigned to corresponding anchors with the smallest summed horizontal distance between the centerline and the anchor at each of the sampling points.

The present techniques result in a variety of benefits over existing techniques. For example, making local (e.g., per-point) and/or global (e.g., per-anchor) predictions using features sampled along each anchor facilitates learning translation-invariant features and avoids the need to encode point locations, which should improve detection accuracy over prior techniques. Furthermore, the use of slanted and curved anchors facilitates more accurate predictions for slanted and curved lanes and other surface features, and facilitates use of the summed distance metric over multiple sampling points to associate ground truth labels with corresponding anchors, both of which facilitate improved handling of splits and merges anywhere in the field of view over prior techniques. The per-point visibility score for points along each anchor facilitates reconstruction and/or an improved awareness of invisible, unmarked, or occluded portions of a surface feature (e.g., lane line) by downstream component(s), facilitating improved navigation and safety. Predicting a lane as a centerline and lateral offsets and decoding the locations of the left and right rails allows the DNN(s) to benefit from redundant information and facilitates robustness to invisibility of one of the two rails. Refining predictions in a second stage (and/or subsequent refinement stages) improves prediction accuracy for lanes that have significant curvature by effectively predicting offsets relative to predicted offsets. Embodiments that provide interacting or coupled branches for processing local (e.g., per-point) features sampled from or around different points along the anchor improve awareness of the overall shape of detected surface features (e.g., a detected lane), improving the DNN(s) ability to learn which shapes are more realistic and which are less likely. Since each prediction may be associated with a predefined anchor, surface features such as lane lines may be localized and decoded without the need for the post-hoc clustering, autoregressive decoding, and polyline reconstruction used by anchor-free detectors. Finally, the various techniques described herein facilitate simpler architectures and lower computational demands compared to prior techniques such as query-based detectors, making the present detection techniques easier to train, less dependent on large datasets, and more compatible with real-time inference systems.

As such, the techniques described herein may be used to detect, classify, regress, and/or decode the shape of one or more surface features, and the detected surface features may be used to enable localization, safe planning, and control of an autonomous vehicle, semi-autonomous vehicle, machine, robot, and/or other object or machine type. For example, detected surface features may aid an autonomous or semi-autonomous machine (or a remote operator) in navigating a physical environment, and may aid in localization for more accurate and safe navigation. As a result, various embodiments provide a way to detect lane lines (e.g., solid lane lines, dotted lane lines) and other classes of surface features—and regress their shape—from input LiDAR data and other sensor data, thereby enabling a faster and more precise localization than in conventional methods.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to detect surface features (e.g., curved or straight lines approximating lane lines or boundaries of a navigable surface, etc.), and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., perception data indicative of lane line or road boundary markings, other surface markings, traffic signs, road signs, informational signs, etc.—from within the simulation. The synthetic training data (in addition to or alternatively from real-world data) may then be used or processed to determine path or lane behavior and localize a machine with respect to a higher-level (e.g., less detailed) map associated with the environment, such as determining behaviors of different paths in a warehouse to determine which paths lead to which areas of the warehouse, for example.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to identify lane lines, road boundary lines, longitudinal features, lane behaviors, etc. that may be included in a visualization or mapping of an environment to aid a remote operator in controlling—or providing waypoints or other indications of control or navigation—an autonomous or semi-autonomous machine through an environment. As such, the remote operator may use the visualization to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment (e.g., perceive surface features such as lanes, paths, boundaries of navigable surfaces, etc.) and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

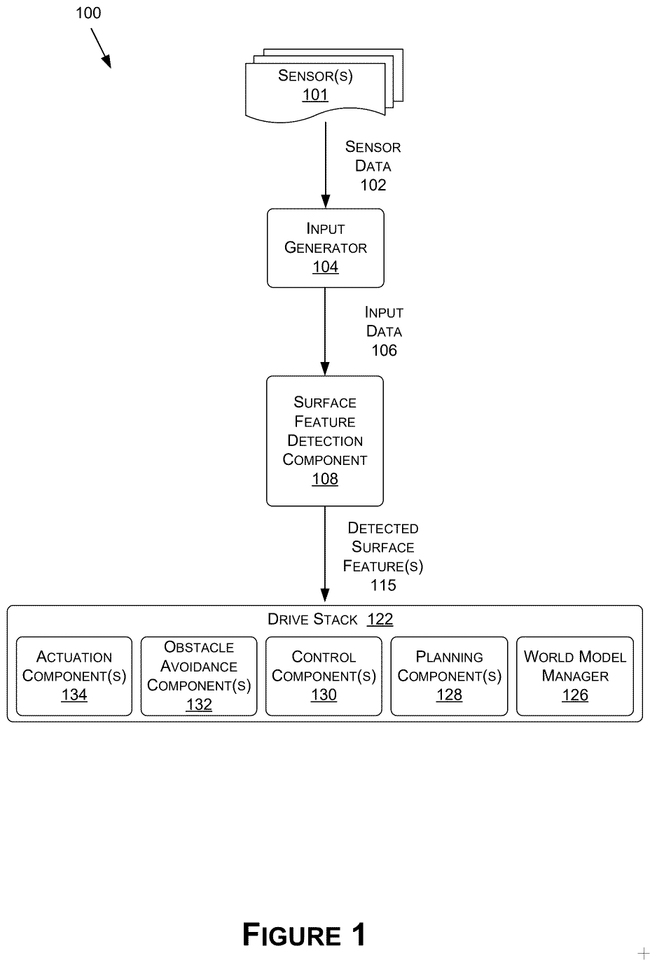

With reference to FIG. 1, FIG. 1 illustrating an example surface feature detection system 100, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 800 of FIGS. 8A-8E, example computing ecosystem 900 of FIG. 9, example generative language model system 1000 of FIG. 10, and/or example computing device 1100 of FIG. 11.

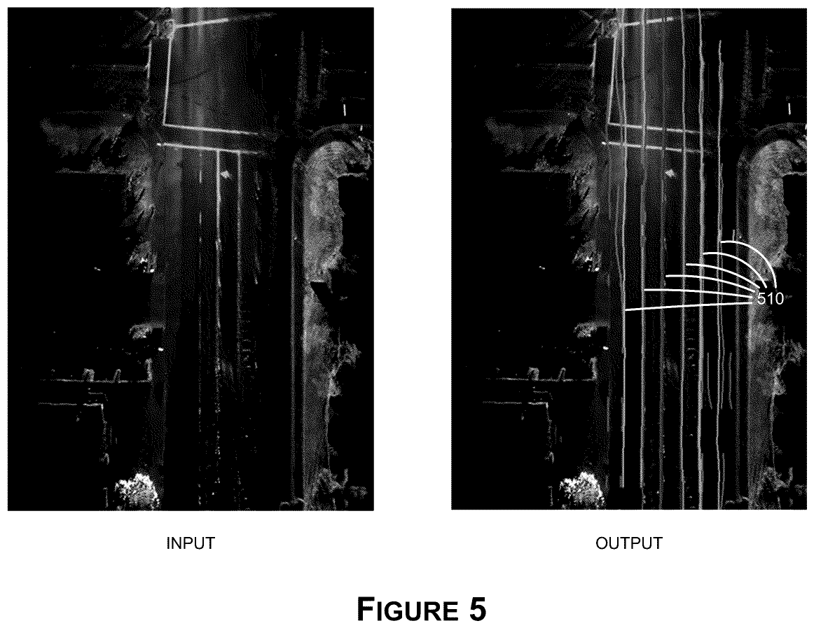

At a high level, the surface feature detection system 100 may include a surface feature detection component 108 that uses one or more machine learning models to detect surface features such as lane lines and regress a parameterization of a curved or straight line representing their shape. In the example illustrated in FIG. 1, one or more sensors 101 of a real or simulated ego-machine (e.g., the autonomous or semi-autonomous vehicle, robot, or machine 800 of FIGS. 8A-8E) may be used to generate sensor data 102 representing a three-dimensional (3D) environment, and an input generator 104 may process the sensor data 102 into input data 106 that the surface feature detection component 108 accepts. As such, the surface feature detection component 108 may generate a representation of detected surface feature(s) 115 represented in the input data 106, and may provide a representation of the detected surface feature(s) 115 to control component(s) of the ego-machine (e.g., the drive stack 122, controller(s) 836, ADAS system 838, SOC(s) 804, and/or other components of the autonomous vehicle 800 of FIGS. 5A-5D) to aid the ego-machine in performing one or more operations (e.g., obstacle avoidance, path planning, mapping, navigation, control, etc.) within the environment. Although primarily described herein as a stack, control stack, or driving stack, this is not intended to be limiting, and the systems and methods described herein may alternatively be referred to as a processing pipeline, a process, a control stack, a driving stack, a software stack, a hardware/software stack, etc., without departing from the scope of the present disclosure. As such, the drive stack 122 or other control component(s) of the ego-machine may use (or at least consider) the detected surface feature(s) 115 for localization and/or navigation. The surface feature detection system 100 may operate at any suitable frame rate (e.g., 5 fps, 10 fps, 15 fps, 20 fps, 30 fps, etc.). For example, a frame(s) of the sensor data 102 may be generated for each time slice, and the surface feature detection system 100 may use the frame(s) of sensor data 102 for each time slice to detect corresponding surface feature(s), to make localization and/or navigation decisions (e.g., generating a trajectory), and/or to execute corresponding control actions (whether at the same frame rate as the sensor data 102 is generated or some other frame rate).

Generally, the surface feature detection system 100 may use sensor data 102 from any number and/or any type of sensor, such as, without limitation, one or more cameras, LiDAR sensors, RADAR sensors, ultrasonic sensors, and/or other sensor types, such as those described below with respect to the autonomous or semi-autonomous machine 800 of FIGS. 8A-8E, and the input generator 104 may process the sensor data 102 into a format the surface feature detection component 108 accepts. In some embodiments, the sensor(s) 101 may be deployed with an ego-machine and may be used to generate a frame(s) of sensor data 102 that represents a 3D environment the ego-machine is navigating. For example, the sensor data 102 may include one or more images from one or more cameras (e.g., N images from N cameras such as surround view cameras, a stitched image), and which the input generator 104 may stack, concatenate, or otherwise combine in any suitable way. Additionally or alternatively, in some embodiments in which the sensor data 102 includes a representation of measured 3D points (e.g., LiDAR or RADAR point clouds), the input generator 104 may accumulate the measured 3D points (e.g., over a designated number of time slices, LiDAR or RADAR spins, etc.), transform the measured 3D points to a single coordinate system (e.g., centered around an origin of a rig coordinate system of the ego-machine), ego-motion-compensate the measured 3D points (e.g., to a latest known position of the ego machine), and/or project the measured 3D points to form a projection image representing any suitable view of the 3D environment (e.g., perspective, orthographic), having any number of channels (e.g., a single channel image, a multi-channel image or tensor) representing any characteristic of the sensor data 102 (e.g., projected position of a measured 3D point, one or more reflection characteristics, image data such as pixel color, etc.). For example, an (accumulated, ego-motion-compensated) LiDAR point cloud may be projected to form a LiDAR range image with a perspective view or a top-down (e.g., bird's eye view (BEV)) representation of projected 3D locations of measured 3D points (e.g., an elevation map), with any number of channels (e.g., storing reflection characteristics such as intensity, elevation or range profile, etc.). In some embodiments, different sensors may be used to generate different modalities of sensor data 102 (e.g., camera images, LiDAR range images, etc.) having the same (e.g., perspective) view of the 3D environment in a common image space, and the input generator 104 may store sensor data 102 from the different sensors and/or sensor modalities in different channels of a multi-channel image or tensor. These are meant simply as examples, and any suitable representation of the 3D environment and/or the state of the ego-machine may be used as at least a portion of the sensor data 102, which the input generator 104 may format into the input data 106 using suitable data structures with any suitable size, dimensionality, etc.

By way of non-limiting example, a frame may correspond to a full-spin accumulated LiDAR 3D point cloud that has been ego-motion-compensated to a defined time point within the spin. While any given frame by itself may only yield a limited number of scan lines on a target object or surface (e.g., a road surface), leveraging multiple frames may yield a denser representation of the target object or surface. In some embodiments, the input generator 104 may use a sliding window of multiple frames to build a dense 3D point cloud. As such, the input generator 104 may project a dense 3D point cloud into a projection image (e.g., an orthographic surface image) with any number of channels storing corresponding reflection characteristics bearing, azimuth, elevation, range, intensity, reflectivity, SNR, etc.), and the projection image may be used as the input data 106. In some embodiments, for each pixel or grid cell that bins sensor data representing multiple reflections, a set of features may be calculated, determined, or otherwise selected from reflection characteristics of the reflections (e.g., bearing, azimuth, elevation, range, intensity, reflectivity, SNR, etc.). In some embodiments, when there are multiple reflections binned together in a pixel or grid cell, thereby forming a tower of points, a particular feature for that pixel or grid cell may be calculated by aggregating a corresponding reflection characteristic for the multiple overlapping reflections (e.g., using standard deviation, average, etc.). In some implementations, reflections (e.g., LiDAR returns) may be classified into ground and non-ground points using any known technique, and each pixel or grid cell may store characteristics of the ground and/or non-ground points that project onto that pixel. By way of non-limiting example, each grid cell may store the average intensity, average elevation, and/or other characteristics of ground points that project onto the grid cell and/or the average intensity, average elevation, maximum height above ground, and/or other characteristics of non-ground points that project onto the grid cell in corresponding channels. Generally, any given pixel or grid cell of the input data 106 may have multiple associated features values, which may be stored in corresponding channels of a multi-channel image or tensor corresponding.

At a high level, the surface feature detection component 108 may be implemented using any type of machine learning model or neural network such as those described herein and may be used to predict or generate a representation of detected surface feature(s) 115 and/or regress a representation of (e.g., curved or straight) 2D or 3D polylines representing their shapes using the input data 106. The surface feature detection component 108 may support a variety of classes or types of detected surface feature(s) 115 and may fit a curved or straight line to each of the detected surface feature(s) 115. More specifically, the surface feature detection component 108 may accept and process the input data 106 in one or more (e.g., two-dimensional (2D)) views (e.g., a top-down view or BEV), which may be divided into straight and/or curved strips, columns, rows, segments, or other regions corresponding to a set of predefined straight and/or curved anchors. For each anchor, the surface feature detection component 108 may predict an anchor-level existence or confidence score indicating a likelihood that a surface feature is present near (e.g., along) the anchor, and for each of a set of predefined points along the anchor, one or more per-point predictions such as regressed offset from center, width, elevation, visibility, and/or uncertainty and/or classifications of each such point into one or more supported classes of surface features, including but not limited to surface markings (e.g., solid lane lines, dashed lane lines, double lane lines, etc.), other surface (e.g., road, navigational) elements or features (e.g., road boundaries, intersection boundaries), landmarks (e.g., traffic lights, traffic signs, informational signs, poles), sub-classes of one or more of the foregoing (e.g., a left or right rail of a particular class of lane line, etc.), and/or otherwise. The applicable view may be designed or selected based on the type of surface feature to detect. For example, lane line and road boundaries may be detected and corresponding (e.g., 3D) polylines may be regressed in a top-down view or perspective view, whereas traffic lights, traffic signs, informational signs, and/or poles may be better suited for detection and polyline regression in perspective view. Furthermore, the type of anchor may be designed or selected based on the applicable use case. Taking highway driving as an example, lanes and offramps may be predominantly longitudinal or vertical in top-down view so a set of vertical, slanted, and/or curved anchors may be used. Taking urban driving as an example, intersections may introduce more variety in potential lane orientations in top-down view, so a set of vertical, horizontal, slanted, and/or curved anchors may be used. These are just a few examples, and variations may be implemented within the scope of the present disclosure.

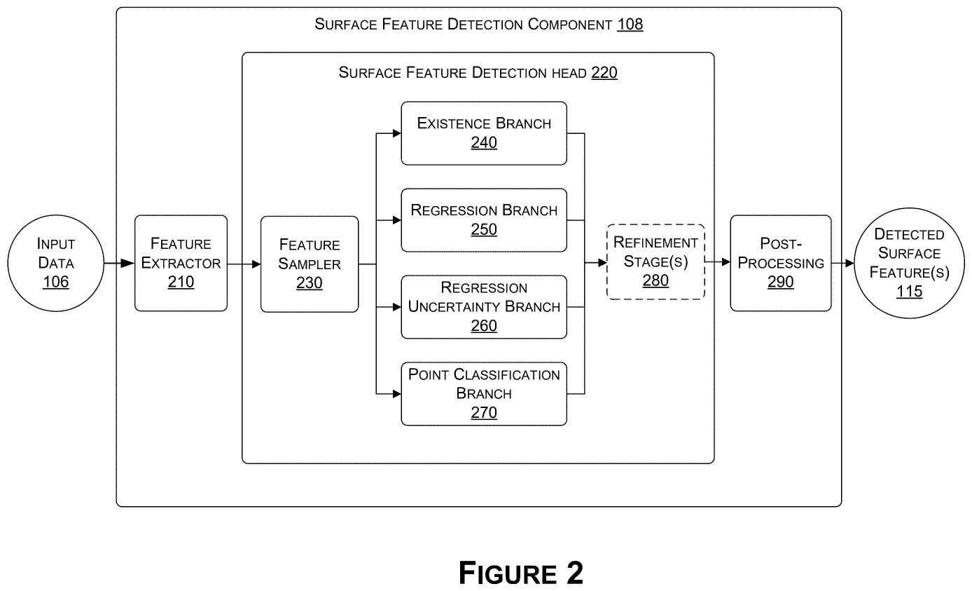

FIG. 2 is an example surface feature detection component 108, in accordance with some embodiments of the present disclosure. In this example, the surface feature detection component 108 includes a feature extractor 210 that may extract features (e.g., a feature map) from the input data 106, and a surface feature detection head 220 that may sample from the extracted features along each anchor and process the sampled features through one or more shared processing layers to generate classification and/or regression data representing global (per-anchor) and/or local (e.g., per-anchor-point) predictions. In some embodiments, the surface feature detection head 220 may use one or more refinement stages 280 to refine the classification and/or regression data. Depending on the implementation, the classification and/or regression data may be used as the detected surface feature(s) 115, and/or post-processing 290 may be applied to generate some other representation of at least a portion of the detected surface feature(s) 115.

The feature extractor 210 may be implemented using any type of machine learning model or neural network (e.g., a backbone network, feature extractor, etc.) such as those described herein. For example, the feature extractor 210 may include, without limitation, one or more convolutional layers, transformer layers, pooling layers, and/or other layer types, and the feature extractor 210 may be used to extract a latent representation of the scene represented by the input data 106 (e.g., a feature map). In an example implementation, the feature extractor 210 includes a backbone encoder network such as EfficientNet that extracts features and a convolutional neural network (CNN) neck that acts as a feature processing layer to refine the extracted features (e.g., by applying strided 2D convolutions).

The surface feature detection head 220 may be implemented using any type of machine learning model or neural network such as those described herein. In the example illustrated in FIG. 2, the surface feature detection head 220 includes a feature sampler 230 that samples from the features extracted by the feature extractor 210 at one or more locations corresponding to each supported anchor, and the sampled features for each anchor may be applied to one or more output heads and/or output branches such as an existence branch 240, a regression branch 250, a regression uncertainty branch 260, and/or a point classification branch 270.

More specifically, and taking a longitudinal or vertical anchor in top-down view as an example, the anchor may be associated with some number of (e.g., equally spaced) sampling points (e.g., fifty), and the feature sampler 230 may sample the extracted features along the anchor at locations corresponding to the sampling points. The sampling points may be fixed relative to each anchor (e.g., the feature sampler 230 may sample at a set of predetermined points on each anchor), or the sampling points may be learned (e.g., the feature sampler 230 may sample at a set of points separated from a set of baseline sampling points by a corresponding set of learned or deformable offsets). In some embodiments, the fixed or baseline sampling points may be equally spaced in one direction in a given view (e.g., longitudinally or vertically in a top-down view) along straight (e.g., longitudinal or vertical, slanted) and/or curved anchors, and the regression branch 250 may predict local (per-point) features representing per-point lateral offsets from center and/or surface feature width in a corresponding lateral direction(s) in that view, independent of the direction of the anchor (e.g., slanted, diagonal, curved). Predicting offsets and/or widths in a particular direction independent of the direction of the anchor (e.g., straight, slanted, diagonal, curved) may result in offsets that are perpendicular to some anchors but not to others, but should simplify the prediction task for the surface feature detection head 220 across all anchors. By way of illustration and taking a top-down implementation as an example, there may be a few hundred supported anchors, including vertical anchors representing longitudinal lines in the top-down view and slanted or diagonal (e.g., left-to-right and right-to-left) anchors representing slanted or diagonal lines in the top-down view, and the vertical and slanted or diagonal anchors may each be sampled equidistantly along the vertical axis. These are just a few examples, and variations may be implemented within the scope of the present disclosure.

As such, for each anchor, the feature sampler 230 may sample local (per-point) features at locations corresponding to the sampling points for that anchor (at fixed points and/or using learned or deformable offsets), and may apply the sampled features in a corresponding anchor-wise pass through the output head(s) and/or output branch(es) (e.g., the existence branch 240, the regression branch 250, the regression uncertainty branch 260, the point classification branch 270) to generate corresponding predictions for that anchor. The feature sampler 230 may repeat the process for each anchor to generate corresponding predictions for each anchor.

For example, the regression branch 250 may regress a parameterization of a (curved or straight) 2D or 3D polyline relative to each anchor. For example, the regression branch 250 may accept the local (per-point) features sampled from or around different points along the anchor and may process the local (per-point) features through disjoint or parallel branches independently of one another—or may process the local (per-point) features through interacting or coupled branches that interact via operations such as convolution or self-attention. In some embodiments, the regression branch 250 may be made aware of global (per-anchor) features by aggregating (e.g., concatenating or adding) the local (e.g., per-point) features with the global (per-anchor) features extracted by the existence branch 240. As such, the regression branch 250 may output one or more per-point predictions such as a regressed lateral offset representing the location of a center line of a detected surface feature relative to each sampling point, regressed width of the detected surface feature at each sampling point, regressed elevation for each sampling point, and/or a representation of the visibility of the sampling point. In this example, the surface feature detection component 108 may effectively detect and represent a given surface feature (e.g., lanes, navigable surface such as a road) based on its centerline and width along the sampling points, and the post-processing 290 may convert the predicted values into corresponding left and right edges or rails. The lateral offset, width, and/or elevation may be used with the corresponding coordinate of the sampled point (e.g., the horizontal coordinate of the sampling point) to represent a detected or regressed 2D or 3D point on a corresponding surface feature (e.g., a lane line, a center line, a road boundary, etc.). The predicted visibility may constitute a visibility flag, score, or other indication of whether that point on the surface feature is visible or occluded (e.g., blocked by a car or crest of a hill). Predicting separate visibility flags or scores for different sampling points along each anchor provides more granular detail for detected surface features such that a lane line, for example, need not be continuous along the entire field of view to be detected and represented. The per-point visibility score for points along each anchor facilitates reconstruction and/or an improved awareness of invisible, unmarked, or occluded portions of a surface feature (e.g., lane line) by downstream component(s). In an example implementation, the regression branch 250 may output regression data of size (3,K,N) comprising three predicted values representing a 3D point (e.g., lateral offset of center relative to anchor, width of surface feature, visibility) for each of K vertical steps or sampling points along any given anchor (e.g., 50 equally spaced points in the vertical direction) for each of N anchors (e.g., 300). Any suitable regression loss (e.g., mean squared error, L1 loss) may be used during training. In some embodiments, visibility may be predicted as a classification task (e.g., in a corresponding visibility classification branch of the surface feature detection head 220) instead of or in additional to using a regression task.

In some embodiments, the regression uncertainty branch 260 may regress a representation of uncertainty in the per-point regression data regressed by the regression branch 250. For example, the regression uncertainty branch 260 may accept the local (per-point) features sampled from or around different points along the anchor and may process the local (per-point) features through disjoint or parallel branches independently of one another—or may process the local (per-point) features through interacting or coupled branches that interact via operations such as convolution or self-attention. In some embodiments, the regression uncertainty branch 260 may be made aware of global (per-anchor) features by aggregating (e.g., concatenating or adding) the local (e.g., per-point) features with the global (per-anchor) features extracted by the existence branch 240. As such, the regression uncertainty branch 260 may output one or more per-point predictions representing regression uncertainty for each sampling point, such as such as deviation (e.g., standard or mean absolute) and/or variance, and/or may output one or more predictions representing regression uncertainty for each regressed value regressed by the regression uncertainty branch 260 (e.g., deviation and/or variance for the predicted lateral offset, width, elevation, etc.). In some embodiments, the regression uncertainty branch 260 may output regression data of size (3,K,N) comprising three predicted values representing a measure of regressed uncertainty for each regressed value predicted by the regression branch 250 for each 3D point (e.g., lateral offset uncertainty, width uncertainty, visibility uncertainty) for each of K vertical steps or sampling points along any given anchor (e.g., 50 equally spaced points in the vertical direction) for each of N anchors (e.g., 300). The loss function used for training may include a term that depends on predicted uncertainty, such as mean absolute deviation(s), standard deviation (σ), variance (σ²), log mean absolute deviation, log standard deviation, log variance, etc. For example, the loss may include any known regression term (e.g., mean squared error, L1 loss) that compares the predicted value at each pixel predicted by the regression branch 250 to ground truth (e.g., treated as the mean) and adjusts the penalty based on the predicted uncertainty predicted by the regression uncertainty branch 260 for that pixel.

The point classification branch 270 may predict per-point classification data indicating the likelihood or confidence that each sampling point belongs to one or more supported classes. For example, the point classification branch 270 may accept the local (per-point) features sampled from or around different points along the anchor and may process the local (per-point) features through disjoint or parallel branches independently of one another—or may process the local (per-point) features through interacting or coupled branches that interact via operations such as convolution or self-attention—and may include any number of classification channels for each point. Examples of potential supported classes include surface markings (e.g., solid lane lines, dashed lane lines, double lane lines, etc.), other surface (e.g., road, navigational) elements or features (e.g., road boundaries, intersection boundaries), landmarks (e.g., traffic lights, traffic signs, informational signs, poles), sub-classes of one or more of the foregoing (e.g., a left or right rail of a particular class of lane line, etc.), and/or otherwise. In some embodiments, the point classification branch 270 may be made aware of global (per-anchor) features by aggregating (e.g., concatenating or adding) the local (e.g., per-point) features with the global (per-anchor) features extracted by the existence branch 240. In some embodiments, the point classification branch 270 may output classification data of size (PPC,K,N) comprising some number of predicted per-point confidence (PPC) values corresponding to the number of supported classes for each sampling point, and for each of K vertical steps or sampling points along any given anchor (e.g., 50 equally spaced points in the vertical direction) for each of N anchors (e.g., 300). Any suitable classification loss (e.g., cross-entropy loss) may be used during training.

The existence branch 240 may predict per-anchor classification data indicating the likelihood or confidence that each anchor represents a detected surface feature (e.g., the likelihood or confidence that a detected surface feature is present or exists along the anchor). For example, the existence branch 240 may accept the local (per-point) features sampled from or around different points along the anchor and may process the local (per-point) features through disjoint or parallel branches independently of one another—or may process the local (per-point) features through interacting or coupled branches that interact via operations such as convolution or self-attention—and/or may aggregate the (e.g., resulting) local (e.g., per-point) features (e.g., using max or average pooling) to generate and classify global (per-anchor) features. In some embodiments, the existence branch 240 may output classification data of size (1,N) comprising a predicted per-anchor confidence value corresponding to each of N anchors (e.g., 300). Any suitable classification loss (e.g., cross-entropy loss) may be used during training.

In some embodiments, one or more refinement stages 280 may be used to make refined predictions from features sampled at offsets predicted by the regression branch 250 in an initial or prior stage. Take an example in which a lane is not perfectly straight in top-down view. In an initial prediction stage, the regression branch 250 may estimate a set of offsets from the straight line, but the larger the misalignment between the lane and the anchor, the more limited the accuracy of the predicted offsets may be. As such, a subsequent refinement stage(s) 280 may be applied for any given anchor (e.g., all anchors, anchors with predicted existence scores below a designated threshold or within a designated range, anchors with an aggregate measure of the predicted per-point confidence scores below a designated threshold or below a designated threshold, etc.). More specifically, the feature sampler 230 may sample the features extracted by the feature extractor 210 at locations corresponding to the offsets predicted by the regression branch 250 in the previous stage, and the sampled features may be applied one or more output heads and/or output branches (e.g., the existence branch 240, the regression branch 250, the regression uncertainty branch 260, the point classification branch 270) to make updated predictions. Depending on the implementation, the refinement stage(s) 280 may use the same set of shared layers and shared weights as the initial stage such that multiple passes may be made through the same set of shared layers to make initial and refined predictions, or the refinement stage(s) 280 may use different set(s) of shared layers such that initial and refined predictions may be made using different sets of shared layers and/or different instances of a common set of shared layers with different sets of shared weights. Sampling extracted features from offsets predicted in a prior stage should effectively sample from more accurate locations, so the refinement stage(s) 280 may serve to predict a more accurate set of offsets (and other per-point and/or per-anchor predictions), resulting in more accurate predictions for all outputs (e.g., including per-anchor predictions). Generally, any number of refinement stage(s) 280 may be implemented.

Generally, training data for the surface feature detection component 108 may be obtained and/or generated in various ways. For example, input training data may be generated from sensor data using the techniques for operating the surface feature detection component 108 described herein. Corresponding ground truth training data may be generated in various ways. In some embodiments, the sensor data and/or corresponding input training data (e.g., a projection image) may be annotated (e.g., manually, automatically, etc.) with 2D or 3D polylines and corresponding class labels identifying the locations, geometry, orientations, and/or classes of the instances of the relevant surface features represented in the sensor data. The labels may be generated within a drawing program (e.g., an annotation program), computer aided design (CAD) program, labeling program, another type of suitable program, and/or may be hand drawn, in some examples. In any example, the labels may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

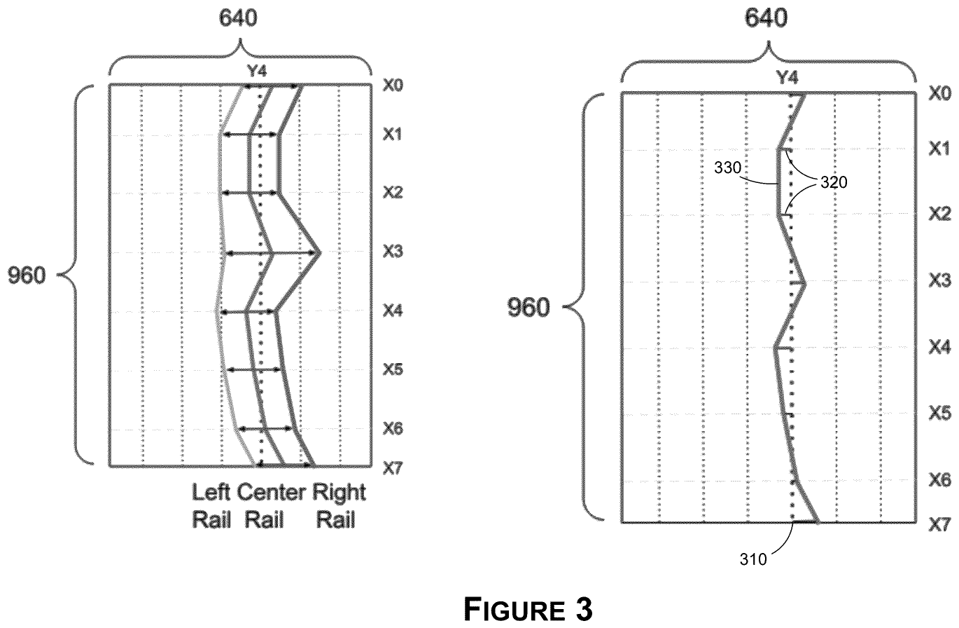

As such, the ground truth annotations may be converted into corresponding ground truth data matching the size and dimensionality of the output(s) of the surface feature detection head 220. Taking lanes as an example, the ground truth annotations may identify a lane's left and right edges or rails, whereas the surface feature detection head 220 may predict the center line and lateral offsets relative the center the line. As such, to convert the ground truth annotations to the corresponding format and assign them to a corresponding anchor, the annotation's left and right edges or rails may be resampled at the supported number of sampling points per anchor (e.g., at fixed values along the vertical axis), and the sampled points on the left and right edges or rails may be converted to corresponding 2D or 3D center points and widths at the sampling points. By way of illustration, the left side of FIG. 3 represents an example with left and right rights resampled along the vertical (x) axis and converted to corresponding points along the center rail and widths (denoted in FIG. 3 with left-to-right arrows). In some embodiments that predict a boundary line (e.g., of a navigable surface such as a road), an annotated boundary line may be resampled at the supported number of sampling points per anchor.

To associate a resulting ground truth polyline (e.g., a center line for ground truth lanes, a boundary of a ground truth navigable surface) with a corresponding anchor, a measure of similarity or difference between the polyline and each of the supported anchors may be computed, and the polyline may be assigned to the anchor with the highest similarity or smallest difference. Taking a center line for a ground truth lane as an example, the total L2 distance to any given anchor (e.g., the anchor 310 in FIG. 3) may be determined by computing the lateral offsets (e.g., offsets 320) between the sampled center points on the center line (e.g., center line 330) and the anchor (e.g., in the lateral direction) and summing the lateral offsets for all sampled center points. As such, the center line may be associated with its nearest anchor (e.g., the anchor with the minimum L2 distance from the center line).

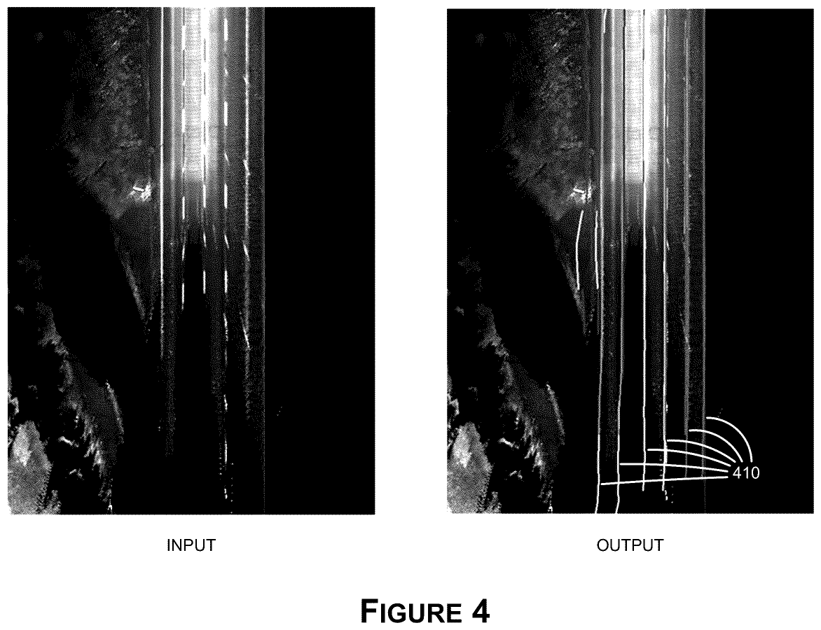

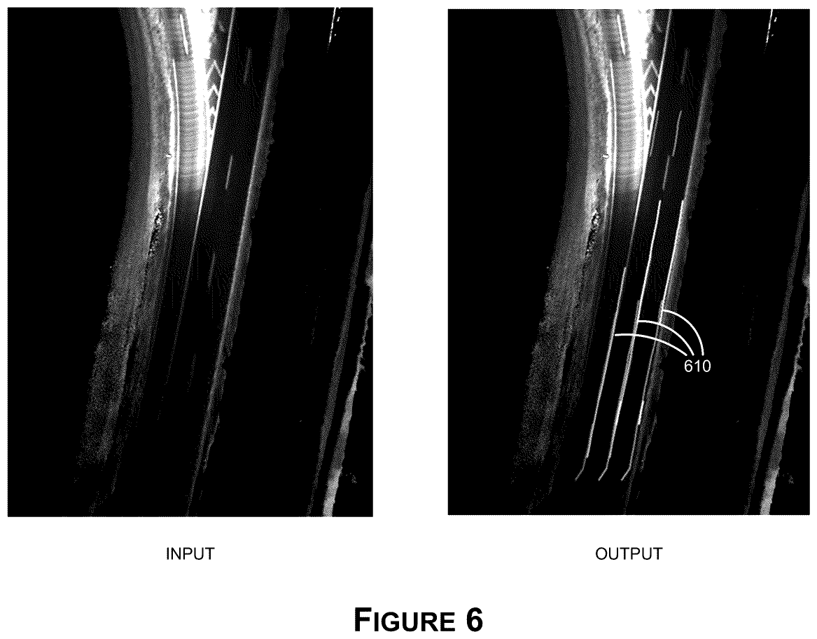

Accordingly, an annotated surface feature may be used to compute corresponding per-point regression data (e.g., per-point lateral offset relative to the selected anchor, width, elevation, visibility), per-point classification data (e.g., assigning each point to a corresponding labeled class), and/or per-anchor classification data (e.g., assigning annotated surface features a value representing a positive classification such as one), and the resulting ground truth data may be used for that anchor's anchor-wise pass during training. Anchors that were not associated with annotated surface features may be assigned ground truth data representing the absence of such features (e.g., zeros or null values). As such, one or more loss functions (e.g., a single loss function, a loss function for each output type, etc.) may be used to compare the accuracy of the output(s) of the surface feature detection head 220 to ground truth, and the parameters of the feature extractor 210 and/or the surface feature detection head 220 may be updated (e.g., using backward passes, backpropagation, forward passes, etc.) until the accuracy reaches an optimized or desired level. FIGS. 4-6 illustrate example pairs of input data (e.g., corresponding to the input data 106 of FIG. 1 or 2) and corresponding detected surface features 410, 510, and 610 which may be predicted and/or decoded by the surface feature detection component 108 of FIG. 1 or 2), in accordance with some embodiments of the present disclosure.

As such, and returning to FIG. 1, a representation of the detected surface feature(s) 115 may be provided to and used by control component(s) of the ego-machine (e.g., the autonomous vehicle 800 depicted in FIGS. 8A-8D), such as an autonomous driving software stack 122 executing on one or more components of the vehicle 800 (e.g., the SoC(s) 804, the CPU(s) 818, the GPU(s) 820, accelerators, etc.). Generally, the surface feature detection system 100 may be deployed in any suitable ego-machine (e.g., a vehicle, a robot, a forklift, etc.) and may run in real-time using one or more systems-on-a-chip (which may correspond to the SoC(s) 804 of FIGS. 8A-8E) of the ego-machine (e.g., an automotive SoC such as NVIDIA's DRIVE or Jetson™ Orin™ or Thor™ SoC, which may serve as a central computer for in-vehicle, in-robot, and/or at-the-edge computing). Other types of SoCs which may be used in robots or ego-machines include AI-optimized SoCs (e.g., NVIDIA Jetson Series), robotics SoCs (e.g., for robotics applications such as drones, service robots, or industrial robots), industrial SoCs (e.g., for industrial robots or automation systems for factory automation, robotics, or control systems), drone and unmanned aerial vehicle (UAV) SoCs (e.g., for handling flight control, navigation, and/or real-time video processing), and/or others.

In some embodiments, the detected surface feature(s) 115 (e.g., detected lanes, a detected navigable space, and/or other types of surface features) may be used by one or more layers of the autonomous driving software stack 122 (alternatively referred to herein as “drive stack 122”) to guide path planning and maneuvering decisions. Although primarily described herein as a stack, control stack, or driving stack, this is not intended to be limiting, and the systems and methods described herein may alternatively be referred to as a processing pipeline, a process, a control stack, a driving stack, a software stack, a hardware/software stack, etc., without departing from the scope of the present disclosure.

At a high level, the drive stack 122 may use any known technique to identify trajectories, paths, and/or control actions for the ego-machine to take and may provide the trajectories, paths, and/or control actions to corresponding control component(s) 130 for execution. For example, the drive stack 122 may include planning component(s) 128 such as a policy or planner that applies one or more human-defined or formulated rules or heuristics to make navigation or control decisions (classical planners), a policy or planner that use neural network(s) to predict or generate a planned trajectory or action (neural planners), a policy or planner that relies on a traditional controller to implement classical control algorithms like model predictive control (MPC), some combination thereof (e.g., a neural or classical planner that predicts an action followed by a classical control algorithm that optimizes the predicted control actions), and/or otherwise. As such, the planning component may be used to predict a trajectory, and the control component(s) 130 may use a control algorithm such as model predictive control (MPC) to generate an optimized control action (e.g., accounting for ego-machine dynamics, using an ego-trajectory as a reference to follow or guide its control actions). As such, the control component(s) 130 may coordinate with actuation component(s) 134 (e.g., the brake actuator(s) 848 and/or the steering actuator(s) 856 of the vehicle 800 of FIG. 8A, actuators, motors, servos, etc. of joints and/or wheels/tracks/etc. of a robot (e.g., AMR, humanoid, etc.) for manipulation and/or navigation, etc.) to follow the trajectory or path and/or execute the control actions. Depending on the implementation, the planning component(s) may implement a navigation and/or other control policy, and a generated trajectory may represent a sequence of waypoints and/or actions such as navigation actions (e.g., steering angles, acceleration or throttle, brake pressures, move forward, turn left) and/or manipulation actions (e.g., pick up object, open door).

More specifically, and in an example implementation, the drive stack 122 may include a sensor manager (not shown), perception component(s) (e.g., the surface feature detection component 108, other component(s) corresponding to a perception layer of the drive stack 122), a world model manager 126, planning component(s) 128 (e.g., corresponding to a planning layer of the drive stack 122), control component(s) 130 (e.g., corresponding to a control layer of the drive stack 122), obstacle avoidance component(s) 132 (e.g., corresponding to an obstacle or collision avoidance layer of the drive stack 122), actuation component(s) 134 (e.g., corresponding to an actuation layer of the drive stack 122), and/or other components corresponding to additional and/or alternative layers of the drive stack 122. The input generator 104 and/or the surface feature detection component 108 may, in some examples, be executed by the perception component(s), which may feed up the layers of the drive stack 122 to the world model manager 126, as described in more detail herein.

The sensor manager may manage and/or abstract the sensor data 102 from the sensors of the vehicle 800. For example, and with reference to FIG. 8C, the sensor data 102 may be generated (e.g., perpetually, at intervals, based on certain conditions) by the sensor(s) 101. The sensor manager may receive the sensor data 102 from the sensor(s) 101 in different formats (e.g., sensors of the same type may output sensor data in different formats) and may be configured to convert the different formats to a uniform format (e.g., for each sensor of the same type). As a result, other components, features, and/or functionality of the autonomous vehicle 800 may use the uniform format, thereby simplifying processing of the sensor data 102. In some examples, the sensor manager may use a uniform format to apply control back to the sensor(s) 101 of the vehicle 800, such as to set frame rates or to perform gain control. The sensor manager may update sensor packets or communications corresponding to the sensor data 102 with timestamps to help inform processing of the sensor data 102 by various components, features, and functionality of an autonomous vehicle control system.

A world model manager 126 may use any known technique to generate, update, and/or define a world model based on information generated by and received from the perception component(s) of the drive stack 122 (e.g., the detected surface feature(s) 115). In an example implementation, the perception component(s) may include an obstacle perceiver, a path perceiver, a wait perceiver, a map perceiver, and/or other perception component(s). For example, the world model may be defined, at least in part, based on affordances for obstacles, paths, and wait conditions that can be perceived in real-time or near real-time by the obstacle perceiver, the path perceiver, the wait perceiver, and/or the map perceiver. The world model manager 126 may continually update the world model based on newly generated and/or received inputs (e.g., data) from the obstacle perceiver, the path perceiver, the wait perceiver, the map perceiver, and/or other components of the autonomous vehicle control system.

The world model may be used to help inform planning component(s) 128, control component(s) 130, obstacle avoidance component(s) 132, and/or actuation component(s) 134 of the drive stack 122. The obstacle perceiver may perform obstacle perception that may be based on where the vehicle 800 is allowed to drive or is capable of driving (e.g., based on the location of the drivable or other navigable paths defined by avoiding detected obstacles), and how fast the vehicle 800 can drive without colliding with an obstacle (e.g., an object, such as a structure, entity, vehicle, etc.) that is sensed by the sensors of the vehicle 800 and/or the neural network(s) 208.

The path perceiver (e.g., corresponding to at least a portion of the surface detection component 108) may perform path perception, such as by perceiving nominal paths that are available in a particular situation. In some examples, the path perceiver may further take into account lane changes for path perception. A lane graph (e.g., corresponding to the detected surface feature(s) 115) may represent the path or paths available to the vehicle 800, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information.

The wait perceiver may be responsible to determining constraints on the vehicle 800 as a result of rules, conventions, and/or practical considerations. For example, the rules, conventions, and/or practical considerations may be in relation to traffic lights, multi-way stops, yields, merges, toll booths, gates, police or other emergency personnel, road workers, stopped buses or other vehicles, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 800 of static or stationary infrastructure objects and obstacles. The map perceiver may generate information for the wait perceiver and/or the path perceiver, for example, such as to determine which light at an intersection has to be green for the vehicle 800 to take a particular path.

In some examples, information from the map perceiver may be sent, transmitted, and/or provided to server(s) (e.g., to a map manager of server(s) 878 of FIG. 8D), and information from the server(s) may be sent, transmitted, and/or provided to the map perceiver and/or a localization manager of the vehicle 800. The map manager may include a cloud mapping application that is remotely located from the vehicle 800 and accessible by the vehicle 800 over one or more network(s). For example, the map perceiver and/or the localization manager of the vehicle 800 may communicate with the map manager and/or one or more other components or features of the server(s) to inform the map perceiver and/or the localization manager of past and present drives or trips of the vehicle 800, as well as past and present drives or trips of other vehicles. The map manager may provide mapping outputs (e.g., map data) that may be localized by the localization manager using any known technique (e.g., based on a detected location of the vehicle 800, the detected surface feature(s) 115, etc.) and the localized mapping outputs may be used by the world model manager 126 to generate and/or update the world model.

In an example implementation, the planning component(s) 128 includes a route planner, a lane planner, a behavior planner, and a behavior selector, among other components, features, and/or functionality. The route planner may use the information from the map perceiver, the map manager, and/or the localization manger, among other information, to generate a planned path or trajectory that may consist of GNSS waypoints (e.g., GPS waypoints), 3D world coordinates (e.g., Cartesian, polar, etc.) that indicate coordinates relative to an origin point on the vehicle 800, etc. The waypoints may be representative of a specific distance into the future for the vehicle 800, such as a number of city blocks, a number of kilometers, a number of feet, a number of inches, a number of miles, etc., that may be used as a target for the lane planner.

The lane planner may use the lane graph (e.g., the detected surface feature(s) 115, which may correspond to the lane graph from the path perceiver), object poses within the lane graph (e.g., according to the localization manager), and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The behavior planner may determine the feasibility of basic behaviors of the vehicle 800, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) 130 may follow a trajectory or path (lateral and longitudinal) that has been received from the behavior selector of the planning component(s) 128 (e.g., based on the detected surface feature(s) 115) as closely as possible and within the capabilities of the vehicle 800. The control component(s) 130 may use tight feedback to handle unplanned events or behaviors that are not modeled and/or anything that causes discrepancies from the ideal (e.g., unexpected delay). In some examples, the control component(s) 130 may use a forward prediction model that takes control as an input variable, and produces predictions that may be compared with the desired state (e.g., compared with the desired lateral and longitudinal path requested by the planning component(s) 128). The control(s) that minimize discrepancy may be determined.

Although the planning component(s) 128 and the control component(s) 130 are illustrated separately, this is not intended to be limiting. For example, in some embodiments, the delineation between the planning component(s) 128 and the control component(s) 130 may not be precisely defined. As such, at least some of the components, features, and/or functionality attributed to the planning component(s) 128 may be associated with the control component(s) 130, and vice versa. This may also hold true for any of the separately illustrated components of the drive stack 122.

The obstacle avoidance component(s) 132 may aid the autonomous vehicle 800 in avoiding collisions with objects (e.g., moving and stationary objects). The obstacle avoidance component(s) 132 may include a computational mechanism at a “primal level” of obstacle avoidance, and may act as a “survival brain” or “reptile brain” for the vehicle 800. In some examples, the obstacle avoidance component(s) 132 may be used independently of components, features, and/or functionality of the vehicle 800 that is required to obey traffic rules and drive courteously. In such examples, the obstacle avoidance component(s) may ignore traffic laws, rules of the road, and courteous driving norms in order to ensure that collisions do not occur between the vehicle 800 and any objects. As such, the obstacle avoidance layer may be a separate layer from the rules of the road layer, and the obstacle avoidance layer may ensure that the vehicle 800 is only performing safe actions from an obstacle avoidance standpoint. The rules of the road layer, on the other hand, may ensure that vehicle obeys traffic laws and conventions, and observes lawful and conventional right of way (as described herein).

In some examples, detected objects and/or the detected surface feature(s) 115 (e.g., representing a navigable space, detected lanes, or other navigable paths) may be used by the obstacle avoidance component(s) 132 in determining controls or actions to take. For example, the drivable paths may provide an indication to the obstacle avoidance component(s) 132 of where the vehicle 800 may maneuver without striking any objects, structures, and/or the like, or at least where no static structures may exist.

In non-limiting embodiments, the obstacle avoidance component(s) 132 may be implemented as a separate, discrete feature of the vehicle 800. For example, the obstacle avoidance component(s) 132 may operate separately (e.g., in parallel with, prior to, and/or after) the planning layer, the control layer, the actuation layer, and/or other layers of the drive stack 122.

As such, the vehicle 800 may use the detected surface feature(s) 115 (e.g., the edges or rails of detected lanes or other paths) to navigate, plan, or otherwise perform one or more operations (e.g. lane keeping, lane changing, merging, splitting, etc.) within the environment.

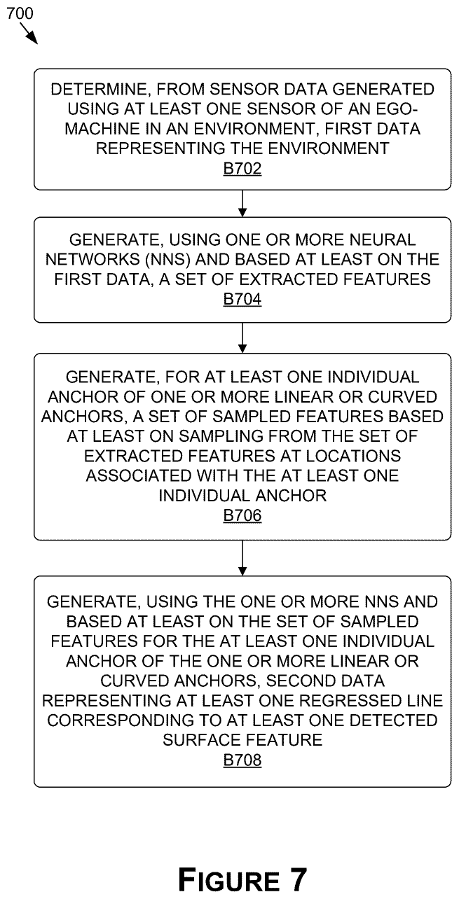

Now referring to FIG. 7, each block of method 700, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The method 700 may be provided by a standalone application, a service or hosted service (standalone or in combination with another hosted service), an application programming interface (API) and/or a plug-in to another product, etc. In addition, the method 700 is described, by way of example, with respect to FIGS. 1 and/or 2. However, this method may additionally or alternatively be executed by any one system, or any combination of systems, including, but not limited to, those described herein.

FIG. 7 is a flow diagram showing a method 700 for generating at least one regressed line corresponding to at least one detected surface feature, in accordance with some embodiments of the present disclosure. The method 700, at block B702, may include determining, from sensor data generated using at least one sensor of an ego-machine in an environment, first data representing the environment. For example, with respect to the surface feature detection system 100 of FIG. 1, the sensor(s) 101 of a real or simulated ego-machine (e.g., the autonomous or semi-autonomous vehicle, robot, or machine 800 of FIGS. 8A-8E) may be used to generate sensor data 102 representing a three-dimensional (3D) environment, and the input generator 104 may process the sensor data 102 into input data 106 that the surface feature detection component 108 accepts.

The method 700, at block B704, may include generating, using one or more Neural Networks (NNs) and based at least on the first data, a set of extracted features. For example, with respect to FIG. 2, the surface feature detection component 108 may include a feature extractor 210 that extracts a latent representation of the scene represented by the input data 106 (e.g., a feature map).

The method 700, at block B706, may include generating, for at least one individual anchor of one or more linear or curved anchors, a set of sampled features based at least on sampling from the set of extracted features at locations associated with the at least one individual anchor. For example, with respect to FIG. 2, the surface feature detection head 220 of the surface feature detection component 108 may include a feature sampler 230 that samples from the features extracted by the feature extractor 210 at one or more locations corresponding to each supported anchor.

The method 700, at block B708, may include generating, using the one or more NNs and based at least on the set of sampled features for the at least one individual anchor of the one or more linear or curved anchors, second data representing at least one regressed line corresponding to at least one detected surface feature. For example, with respect to FIG. 2, the sampled features for each anchor may be applied to one or more output heads and/or output branches such as an existence branch 240, a regression branch 250, a regression uncertainty branch 260, and/or a point classification branch 270 to predict or generate a representation of detected surface feature(s) 115 and/or regress a representation of (e.g., curved or straight) 2D or 3D polylines representing their shapes. Depending on the implementation, the classification and/or regression data may be used as the detected surface feature(s) 115, and/or post-processing 290 may be applied to generate some other representation of at least a portion of the detected surface feature(s) 115.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), vision-language-action (VLA) models, and/or multi-modal language models (MMLMs), systems using or deploying one or more inference microservices, systems that incorporate deploy one or more machine learning models in a service or microservice along with an OS-level virtualization package (e.g., a container), a system for performing one or more wireless cellular transmissions using a wireless cellular network, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### EXAMPLE AUTONOMOUS OR SEMI-AUTONOMOUS MACHINE

FIG. 8A is an example of sensor locations having corresponding fields of view or sensory fields for an autonomous or semi-autonomous vehicle 800a, an autonomous mobile robot (AMR) 800b, and a humanoid robot 800c, in accordance with some embodiments of the present disclosure. Although three types of machines 800 are illustrated, this is not intended to be limiting, and the machine(s) 800 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 800a, AMR 800b, humanoid robot 800c, and/or other machine types may be referred to herein collectively as machine 800, in some instances.

With respect to vehicles 800A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 800 may be capable of functionality in accordance with one or more of Level 3-Level 5 of the autonomous driving levels. The machine 800 may be capable of functionality in accordance with one or more of Level 1-Level 5 of the autonomous driving levels. For example, the machine 800 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 800 or other machine, such as being fully autonomous, being highly autonomous, being conditionally autonomous, being partially autonomous, providing assistive autonomy, being semi-autonomous, being primarily autonomous, or other designation.

With respect to FIG. 8A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 868D, a 180 degree field of view of a wide-view camera 870, a 360 degree sensory field of a LiDAR sensor 864, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 800a, AMR 800b, and/or humanoid robot 800c, etc. For example, with respect to the vehicle 800a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 800b and/or humanoid robot 800c, the shape, size, purpose, implementation, model, etc. may dictate the number and types of sensors used.

As illustrated in FIG. 1A, the autonomous or semi-autonomous vehicle 800A, the AMR 800B, and the humanoid robot 800C may include different sensor types, number, and locations. For a non-limiting example, the vehicle 800A may include twelve cameras 864, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 864 may use, in embodiments, a gigabit multimedia serial link (GMSL) interface such as GMSL2—as input/output (I/O).

In some embodiments, although not illustrated in FIG. 8A, the vehicle 800A may include an in-cabin occupant and/or driver monitoring system, that may include various different sensors. For example, the in-cabin sensors may include various cameras 868, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 868, the internal camera(s) 868 may, in embodiments, use a GMSL (such as GMSL2) interface for I/O.

As another non-limiting example, the vehicle 800A may further include nine RADAR sensors 860. For example, the vehicle 800A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 860 may use, in embodiments, an Ethernet interface as I/O.

The vehicle(s) 800A may further include, as a non-limiting example, twelve ultrasonic sensors 862. As illustrated in FIG. 8A, the ultrasonic sensors may be positioned along the front and rear bumpers of the vehicle 800A, and along the side of the vehicle 800A, and may be used to detect objects (static and dynamic) in close proximity to the vehicle 800A. In some embodiments, the ultrasonic sensor(s) 862 may use a DS13 interface as I/O.

The vehicle(s) 800A may further include, as a non-limiting example, a LiDAR sensor 864, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 864 may include a 360 degree horizontal FOV or sensory field (such as in a spinning LiDAR sensor) and a 90 degree vertical FOV or sensory field. In some embodiment, the LiDAR sensor(s) 864 may use an Ethernet interface as I/O.

The autonomous mobile robot (AMR) 800B may include, as a non-limiting example, three LiDAR sensors 864. For example, the top-most illustrated LiDAR sensor 864 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 800B may further include, as a non-limiting embodiment, eight cameras 868, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree +-3 degree FOV), a rear fisheye camera (e.g., 202 degree +-3 degree FOV), a left fisheye camera (e.g., 202 degree +-3 degree FOV), and a right fisheye camera (e.g., 202 degree +-3 degree FOV).

The AMR 800B may further include a charging port, charging port contacts, a status indicator light, one or more (e.g., four) RGB LEDs, one or more IMU sensors 866, a magnetometer, and a barometer. The AMR 800B is capable of high-precision time synchronization between sensors using hardware time stamping, and PTP over Ethernet with less than 10 microseconds for sensor acquisition time. The AMR 800B provides simultaneous camera capture across all cameras 868 within 100 microseconds from a single hardware trigger, in embodiments, and can write to disk at 4 GB/second for sensor capture to bag writing (e.g., writing to ROSbags for the robot operation system (ROS)). As such, the AMR 800B is capable of running the ROS (such as NVIDIA's Isaac ROS), can be teleoperated (as described herein), can map an environment, and can navigate within an environment using visual cameras 868, LiDARs 864, and/or other sensor types or modalities.

The humanoid robot 800C may include, as a non-limiting example, one LiDAR sensor 864. For example, the LiDAR sensor 864 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 800C may further include, as a non-limiting embodiment, four cameras 868, such as a front stereo camera (e.g., 120 degree FOV), a rear stereo camera (e.g., 120 degree FOV), a front fisheye camera (e.g., 202 degree +-3 degree FOV), and a rear fisheye camera (e.g., 202 degree +-3 degree FOV).

The humanoid robot 800C may further include, as a non-limiting embodiment, four ultrasonic sensors 862, such as a left arm ultrasonic sensor, a right arm ultrasonic sensor, a left leg ultrasonic sensor, and right leg ultrasonic sensor.

The humanoid robot 800C may further include any number of actuators—such as to allow control and maneuverability of joints. For example, the humanoid robot 800C may include actuators that allow for various degrees of freedom (DoF) depending on the design. In a non-limiting embodiment, the humanoid robot 800C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 800C may include position and orientation sensors, such as encoders, gyroscopes, and the like, to determine the position of the robot 800C in space, allowing for location determination and movement tracking. The humanoid robot 800C may include force and pressure sensors, in embodiments, to detect environment interactions, allowing the robot 800C to grasp objects with the right force and to avoid obstacles along the way. The perception sensors (e.g., cameras, LiDARs, RADARs, ultrasonic, SONAR, etc.) may be used along with tactile sensors to allow the robot 800C to perceive objects, shapes, and textures, and to understand when touch is initiated and stopped (along with force sensors that regulate the force used during touch). As a non-limiting example, the humanoid robot 800C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 800C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 800C may use onboard sensors, microphones, and speakers to understanding speech, audio and visual cues, etc., while also being able to communicate back to the environment.

With reference to cameras 868 of the machine(s) 800, the camera types for the cameras 868 may include, but are not limited to, digital cameras that may be adapted for use with the components and/or systems of the machine 800. For a vehicle 800a implementation, the camera(s) 868 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 868B that may be used to perceive objects coming into view from the periphery (e.g., pedestrians, warehouse vehicles, other robots, crossing traffic, or bicycles). In addition, any number of long-range camera(s) 868E (e.g., a long-view stereo camera pair) may be used for depth-based object detection, especially for objects for which a neural network has not yet been trained. The long-range camera(s) 868E may also be used for object detection and classification, as well as basic object tracking.

Any number of stereo cameras 868A may also be included in a front-facing and/or other (e.g., rear-facing) configuration. In at least one embodiment, one or more of stereo camera(s) 868A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 800 environment, including a distance estimate for points in the image (e.g., a disparity or depth image). An alternative stereo camera(s) 868A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 800 (e.g., side-view cameras) may be used, for example, for surround view, providing information used to create and update the occupancy grid, as well as to generate side impact collision warnings and/or to indicate to an AMR 800B or humanoid robot 800C, for example, that there are objects, features, and/or persons present to the side. For example, surround camera(s) 868D may be positioned on the machine 800. The surround camera(s) 868D may include wide-view camera(s) 868B, fisheye camera(s), 360 degree camera(s), and/or the like. For example, four fisheye cameras may be positioned on the machine's 800 front, rear, and sides. In an alternative arrangement, the machine 800 may use three surround camera(s) 868D (e.g., left, right, and rear), and may leverage one or more other camera(s) (e.g., a forward-facing camera) as a fourth surround view camera.

Cameras 868 with a field of view that include portions of the environment to the rear of the machine 800 (e.g., rear-view cameras) may be used for gaining an understanding of objects, features, persons, and/or other information to the rear of the machine 800, such as for park assistance, surround view, rear collision warnings, planning, control, and navigation determinations, and/or creating and updating an occupancy grid, BEV image representing the environment, height map, etc. A wide variety of cameras 868 may be used including, but not limited to, cameras 868 that are also suitable as a front-facing camera(s) (e.g., long-range and/or mid-range camera(s) 868E, stereo camera(s) 868A), infrared camera(s) 868C, etc.), rear-facing camera(s), side-facing camera(s), downward facing camera(s), upward facing camera(s), and/or the like, as described herein.

Similarly, for LiDAR sensors 864, RADAR sensors 860, ultrasonic sensors 862, and/or other sensor modalities or types, the location and placement of the sensors, and their corresponding fields of view or sensory fields may be determined based on the use case, implementation, or design of the particular machine 800.

For example, the machine(s) 800 include RADAR sensor(s) 860 that may be used by the machine 800 for long-range object detection, even in darkness and/or severe weather conditions. RADAR functional safety levels may be ASIL B, in embodiments. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 800 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 860 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 800 (e.g., vehicle, robot, etc.). As such, short-range RADAR systems may be used in an ADAS system for blind spot detection and/or lane change assist.

The machine 800 may further include ultrasonic sensor(s) 862. The ultrasonic sensor(s) 862, which may be positioned at the front, back, and/or the sides of the machine 800, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 800. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B, as an example.

The machine 800 may include LiDAR sensor(s) 864. The LiDAR sensor(s) 864 may be used for object and feature detection, pedestrian and other robot detection, emergency braking, collision avoidance, simultaneous localization and mapping (SLAM), free-space detection, and/or other functions. The LiDAR sensor(s) 864 may be functional safety level ASIL B, in embodiments. In some examples, the machine 800 may include multiple LiDAR sensors 864 (e.g., two, four, six, etc.) that may use Ethernet (e.g., to provide data to a Gigabit Ethernet switch).

In some examples, the LiDAR sensor(s) 864 may be capable of providing a list of objects and their distances for a 360-degree field of view. Commercially available LiDAR sensor(s) 864 may have an advertised range of approximately 800 m, with an accuracy of 2 cm-3 cm, and with support for a 800 Mbps Ethernet connection, for example. In some examples, one or more non-protruding LiDAR sensors 864 may be used. In such examples, the LiDAR sensor(s) 864 may be implemented as a small device that may be embedded into the front, rear, sides, top, and/or corners of the machine 800. The LiDAR sensor(s) 864, in such examples, may provide up to a 120-degree horizontal and 35-degree vertical field-of-view, with a 200 m range even for low-reflectivity objects. Front-mounted LiDAR sensor(s) 864 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 800. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 864 may be less susceptible to motion blur, vibration, and/or shock.

FIG. 8B is an illustration of sensor and component locations of an example autonomous or semi-autonomous vehicle 800A (alternatively referred to herein as “vehicle 800,” “ego-vehicle 800,” “ego-machine 800,” or “machine 800,”), in accordance with some embodiments of the present disclosure. Although the vehicle 800A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 8C is a block diagram of an example system architecture for a machine 800, such as autonomous or semi-autonomous vehicle 800A, autonomous mobile robot (AMR) 800B, humanoid robot 800C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 800 of FIGS. 8A-8E, example computing ecosystem 900 of FIG. 9, example generative language model system 1000 of FIG. 10, and/or example computing device 1100 of FIG. 11.

Each of the components, features, and systems of the machine 800 in FIG. 8C are illustrated as being connected via bus 802 (alternatively referred to as a “machine communications network 802,” or just “communications network 802”). The bus 802 may include a Controller Area Network (CAN) data interface (alternatively referred to herein as a “CAN bus”). A CAN may be a network inside the machine 800 used to aid in control of various features and functionality of the machine 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 802 may include FlexRay, an embedded bus (e.g., SPI, I2C), local interconnect link (LIN), NVIDIA's NVLink, ultra accelerator Link (UALink), USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the machine 800, and two or more busses 802 may communicate with the same components. In some examples, each SoC 804, each controller 836, and/or each computer or compute engine within the machine 800 may have access to the same input data (e.g., inputs from sensors of the machine 800), and may be connected to a common bus, such as a CAN bus.

The machine 800 may include components such as a chassis, a vehicle body, wheels (e.g., 2, 4, 6, 8, 18, etc.), tires, axles, batteries, side-view mirrors, and/or other components of a vehicle or machine. The machine 800 may include a propulsion system 850, such as an internal combustion engine, hybrid electric power plant, an all-electric engine, a hydrogen-fueled engine, and/or another propulsion system type. The propulsion system 850 may be connected to a drive train of the machine 800, which may include a transmission, to enable the propulsion of the machine 800. The propulsion system 850 may be controlled in response to receiving signals from the throttle/accelerator 852.

A steering system 854, which may include a steering wheel and/or other steering device (e.g., remote steering and/or local steering), may be used to steer the machine 800 (e.g., along a desired path or route) when the propulsion system 850 is operating (e.g., when the vehicle is in motion). The steering system 854 may receive signals from a steering actuator 856. In some embodiments, a steering wheel or other steering mechanism may not be included, such as for a machine 800 capable of full automation (e.g., Level 5) functionality.

The brake sensor system 846 may be used to operate the vehicle brakes in response to receiving signals from the brake actuators 848 and/or brake sensors.

The machine 800 may include one or more controller(s) 836, such as those described herein with respect to FIG. 8A. The controller(s) 836 may be used for a variety of functions, and may be coupled to any of the various other components and systems of the machine 800. For example, the controllers 836 may be used for control of the machine 800, artificial intelligence executing on the machine 800, infotainment for the machine 800, and/or the like. For example, one controller 836 may be used for some or all of the functionality, or different controllers 836 may be used for different functionalities—e.g., to ensure availability and a safety separation between various controllers for different tasks. For example, the controller(s) 836 may use plans computed by the system—e.g., paths or trajectories for vehicles 800A or AMRs 800B, or movements, components trajectories, movement locations or displacements, etc. for joints or components (e.g., of manipulators, end effectors, limbs, hands, fingers, legs, feet, etc.), of a humanoid robot 800C—to control the machine(s) 800 in the environment. In some instances, the controller(s) 836 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 800C, for example, the controller(s) 836 may act as the brain, responsible for analyzing sensor data, making decisions, and sending commands to the actuators. The controller(s) 836 may include a low-level controller that handles basic motor control, ensuring accurate and precise movements of individual joints and actuators. The controller(s) 836 may include a high-level controller to coordinate multiple actuators and sensors, planning complex motions and adapting to changing environments.

The controller(s) 836 may include an artificial intelligence controller, in embodiments, that may use AI algorithms (e.g., DNNs, MLMs, etc.) to learn, make decisions, and autonomously perform tasks for the machine 800. In some embodiments, the controller(s) 836 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 836 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 836, which may include one or more systems on chip (SoCs) 804 (FIGS. 8C and 8D), CPUs, GPU(s), accelerator(s), etc., may provide signals (e.g., representative of commands or messages) to one or more components and/or systems of the machine 800. Although the controller(s) 836 is listed separately from the SoC(s) 804, this is not intended to be limiting, and in some embodiments one or more components of the SoC(s) 804 may perform the operations of the controller(s) 836. For example, the controller(s) may send signals to operate the machine brakes via one or more brake actuators 848, to operate the steering system 854 via one or more steering actuators 856, to operate the propulsion system 850 via one or more throttle/accelerators 852, etc. The controller(s) 836 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 800. The controller(s) 836 may include a first controller 836 for autonomous control and navigation functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 836 may handle two or more of the above functionalities, two or more controllers 836 may handle a single functionality, and/or any combination thereof.

The controller(s) 836 may provide the signals for controlling one or more components and/or systems of the machine 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LiDAR sensor(s) 864, inertial measurement unit (IMU) sensor(s) 866 (e.g., accelerometer(s), gyroscope(s), magnetic compass(es), magnetometer(s), etc.), microphone(s) 896, camera(s) 868 (e.g., stereo camera(s) 868A, wide-view camera(s) 868B (e.g., fisheye cameras), infrared camera(s) 868C, surround camera(s) 868D (e.g., 360 degree cameras), long-range and/or mid-range camera(s) 868E, and/or other camera types), speed sensor(s) 844 (e.g., for measuring the speed of the machine 800), vibration sensor(s) 842, steering sensor(s) 840, brake sensor(s) (e.g., as part of the brake sensor system 846), actuators, and/or other sensor types.

One or more of the controller(s) 836 may receive inputs (e.g., represented by input data) from an instrument cluster 832 of the machine 800 and provide outputs (e.g., represented by output data, display data, etc.) via a human-machine interface (HMI) display 834 (e.g., screen, heads-up display, mirror display, facial display, robotic display, etc.), an audible annunciator, a loudspeaker, a speaker, and/or via other components of the machine 800. The outputs may include information such as machine velocity, speed, time, map data corresponding to a map(s) 822 of FIG. 8C (e.g., from a navigation map, a Standard Definition (SD) map, a High Definition (“HD”) map, etc.), location data (e.g., the machine's 800 location, such as on a map 822), direction, location of other vehicles (e.g., an occupancy map, height map, bird's eye view (BEV) image, grid, etc.), information about objects and status of objects as perceived by the system, system status information, etc. For example, the HMI display(s) 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 800 may include one or more systems on a chip (SoCs) 804 (described in more detail in FIG. 8D). The SoC(s) 804 may include CPU(s) 806, GPU(s) 808, processor(s) 810, cache(s) 812, accelerator(s) 814, data store(s) 816, and/or other components and features. The SoC(s) 804 may be used to process and provide data for various operations, such as navigation, planning, reasoning, inference, perception, control, and/or actuation operations of the machine 800 in a variety of platforms and systems. For example, the SoC(s) 804 may process live perception data (e.g., from camera, LiDAR, RADAR, ultrasonic, etc.) in addition to map data corresponding to one or more maps 822 (e.g., HD map, SD map, navigational map, occupancy map, etc.) in order to make or aid in performing various operations of the machine 800. Where a map and/or AI is used, map and/or AI (e.g., model parameter updates, fine-tuning, etc.) refreshes and/or updates via a network interface 824 from one or more servers (e.g., server(s) 878 of FIG. 8E)—such as one or more servers of a cloud-based data center.

Although an SoC(s) 804 is illustrated throughout FIGS. 8A-8E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 800, use of the machine 800, model of the machine 800, and required capabilities of the machine 800, one or more SoCs 804 and/or alternative architectures and/or components may be used to satisfy the particular implementation.

The machine 800 may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The machine 800 may include a GPU(s) 820 (e.g., discrete GPU(s), or dGPU(s)), that may be coupled to the SoC(s) 804 via a high-speed interconnect (e.g., NVIDIA's NVLink, ultra accelerator Link (UALink), etc.). The GPU(s) 820 may provide additional artificial intelligence functionality, such as by executing redundant and/or different neural networks, and may be used to train and/or update neural networks based on input (e.g., sensor data) from sensors of the machine 800.

The machine 800 may further include the network interface 824 which may include one or more wireless antennas 826 and/or modems (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 800 information about vehicles in proximity to the machine 800 (e.g., vehicles in front of, on the side of, and/or behind the machine 800). This functionality may be part of a cooperative adaptive cruise control functionality of the machine 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The machine 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The machine 800 may further include IMU sensor(s) 866. The IMU sensor(s) 866 may be located at a center of the rear axle of the machine 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the machine 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include one or more microphone 896 placed in and/or around the machine 800. The microphone(s) 896 may be used for emergency vehicle detection and identification, among other things.

The machine 800 may further include vibration sensor(s) 842. The vibration sensor(s) 842 may measure vibrations of components of the machine, such as the arms or legs of a humanoid robot 800C, or the axle(s) of a vehicle 800A or AMR 800B. For example, changes in vibrations may indicate a change in road, walking, or traversable surfaces. In another example, when two or more vibration sensors 842 are used, the differences between the vibrations may be used to determine friction or slippage of the surface (e.g., when the difference in vibration is between a power-driven axle and a freely rotating axle).

The machine 800 may include an ADAS system 838—such as when the machine 800 is a vehicle 800A. The ADAS system 838 may include a dedicated SoC(s), in some examples. The ADAS system 838 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 800 may further include the infotainment SoC 830 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the machine 800. In some examples, the infotainment SoC 830 may be coupled to a supervisory MCU such that the GPU of the infotainment system may perform some self-driving functions in the event that the primary controller(s) 836 (e.g., the primary and/or backup computers of the machine 800) fail. In such an example, the infotainment SoC 830 may put the machine 800 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 800—whether a vehicle 800A, AMR 800B, humanoid robot 800C, and/or other type of machine—may include a locally stored language model(s) and/or communicate to a remotely hosted language model (e.g., via one or more APIs) to provide more detailed and in-depth communication features to the users of the machine(s) 800.

In some examples, an infotainment SoC 830, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 800.

The machine 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a block diagram of an example architecture of a computing system (a subset of the system described with respect to FIG. 8C), in accordance with at least some embodiments of the present disclosure. Although illustrated as an SoC(s) 804, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 804 may be an end-to-end platform with a flexible architecture that spans automation levels 2-5, or the SoC(s) 804 may be specifically designed for a specific automation level (e.g., a first SoC 804 for level 2 to level 2++, a second SoC 804 for level 3, a third SoC 804 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 2-5 autonomous vehicles as well as for safe planning, navigation, and control of AMRs 800B, humanoid robots 800C, and/or other robot or machine types.

In some embodiments, such as where the SoC(s) 804 include a GPU 808 with 2000 or more cores (e.g., 2048 cores), 60 or more tensor cores (e.g., 64 tensor cores), and a GPU max frequency of over 1 GHz (e.g., 1.3 GHz), a CPU 806 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 809 (e.g., 2 DLAs/XNNs/NNAs/NPUs 809), and a vision accelerator—such as a programmable vision accelerator (PVA) 807, a single SoC 804) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 804 include a GPU 808 with 1700 or more cores (e.g., 1792 cores), 50 or more tensor cores (e.g., 56 tensor cores), and a GPU max frequency of over 900 MHz (e.g., 930 MHz), a CPU 806 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 809 (e.g., 2 DLAs/XNNs/NNAs/NPUs 809), and a vision accelerator—such as a programmable vision accelerator (PVA) 807, a single SoC 804) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 804 include a GPU 808 with 1000 or more cores (e.g., 1024 cores), 28 or more tensor cores (e.g., 32 tensor cores), and a GPU max frequency of over 900 MHz (e.g., 1173 MHz), a CPU 806 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 809 (e.g., 1 DLA/XNN/NNA/NPU 809), and a vision accelerator—such as a programmable vision accelerator (PVA) 807, a single SoC 804) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 804 include a GPU 808 with 1000 or more cores (e.g., 1024 cores), 28 or more tensor cores (e.g., 32 tensor cores), and a GPU max frequency of over 900 MHz (e.g., 1020 MHz), a CPU 806 including 6 or more cores (e.g., 6 cores), with 64 bits, 1.5 MB L2 and 4 MB L3 cache memory, and a max frequency of 1.5 or more GHz (e.g., 1.7 GHz), a single SoC 804) may be capable of 67 tera operations per second (TOPS) of AI performance. For example, NVIDIA's Jetson Orin Nano 8 GB SoC satisfies these criteria, and achieves this performance.

The SoC(s) 804 may include one or more CPUs 806. The CPU(s) 806 may include a CPU cluster or CPU complex (alternatively referred to herein as a “CCPLEX”), in embodiments. The CPU(s) 806 may include multiple cores and/or (e.g., L2, L3) caches. For example, in some embodiments, the CPU(s) 806 may include twelve cores in a coherent multi-processor configuration. In some embodiments, the CPU(s) 806 may include four dual-core clusters where each cluster has a dedicated L2 cache (e.g., a 3 MB L2 cache). The CPU(s) 806 (e.g., the CCPLEX) may be configured to support simultaneous cluster operation enabling any combination of the clusters of the CPU(s) 806 to be active at any given time.

The SoC(s) 804 may include any type and number of GPUs 808. For example, an integrated GPU(s) (alternatively referred to herein as an “iGPU(s)”) may be used in some embodiments. The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive, robotics, and/or other embedded use cases. For example, the GPU(s) 808 may be fabricated on a Fin field-effect transistor (FinFET). However, this is not intended to be limiting and the GPU(s) 808 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

The SoC(s) 804 may include any number of cache(s) 812, including those described herein. For example, the cache(s) 812 may include L0 caches, L1 caches, L2 caches, L3 caches (e.g., that are available to both the CPU(s) 806 and the GPU(s) 808 (e.g., that is connected both the CPU(s) 806 and the GPU(s) 808)), etc. The cache(s) 812 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 804 may include one or more arithmetic logic units (ALUs) 865 which may be leveraged in performing processing with respect to any of the variety of tasks or operations of the machine 800—such as computer vision, machine learning or deep learning processing, world model management, etc. In addition, the SoC(s) 804 may include a floating point unit(s) (FPU(s)) 867—or other math coprocessor or numeric coprocessor types—for performing mathematical operations within the system. For example, the SoC(s) 104 may include one or more FPUs 867 integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory 815 (e.g., 4 MB of SRAM, 32 GB and/or 64 GB 256-bit LPDDR 5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 814 (e.g., the hardware acceleration cluster) may include a deep learning accelerator(s) (DLA) 809 (alternatively referred to herein as “a deep learning accelerator cluster (XNN) 809,” “neural network accelerator (NNA) 809,” or “neural processing unit (NPU) 809”). The DLA(s) 809 may include one or more Tensor processing units (TPUs) 841 that may be configured to provide an additional, e.g., ten trillion operations per second for deep learning applications and inferencing. The TPUs 841 may be accelerators configured to, and optimized for, performing image processing functions (e.g., for CNNs, RCNNs, DNNs, etc.). The DLA(s) 809 may further be optimized for a specific set of neural network types and floating point operations, as well as inferencing. The design of the DLA(s) may provide more performance per millimeter than a general-purpose GPU, and vastly exceeds the performance of a CPU. The TPU(s) 841 may perform several functions, including a single-instance convolution function, supporting, for example, INT8, INT16, and FP16 data types for both features and weights, as well as post-processor functions. Although the TPU(s) 841 are described as being included as part of the DLA(s) 809, this is not intended to be limiting, and the TPU(s) 841 may be included in additional or alternative accelerator(s) 814 and/or other components, and/or may be included as a discrete processing component(s).

The DLA(s) 809 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 809 may perform any function of the GPU(s) 808, and by using an inference accelerator, for example, a designer may target either the DLA(s) 809 or the GPU(s) 808 for any function. For example, the designer may focus processing of DNNs and floating point operations on the DLA(s) 809 and leave other functions to the GPU(s) 808 and/or other accelerator(s) 814. The DLA(s) 809 may be used to run any type of network to enhance control and safety, including for example, a neural network that outputs a measure of confidence for each object detection.

The accelerator(s) 814 (e.g., the hardware acceleration cluster) may include a programmable vision accelerator(s) (PVA) 807, which may alternatively be referred to herein as a computer vision accelerator or generally a vision accelerator. The PVA(s) 807 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 807 may provide a balance between performance and flexibility. For example, each PVA(s) 807 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 807 may be optimized for the tasks of image processing and computer vision algorithm acceleration. For example, the PVA(s) 807 provides excellent performance with extremely low power consumption, and can be used asynchronously and concurrently with the CPU(s) 806, GPU(s) 808, and/or other accelerators in the system (e.g., vehicle, robot, etc.) as part of a heterogeneous compute pipeline.

The PVA(s) 807 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 843 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 806 (e.g., ARM Cortex-R5 processor), facilitating data exchange with the CPU(s) 806 and other system-level components. The VPU I-cache may supply instruction data to the VPU(s) when requested, may request missing instruction data from system memory, and/or may maintain temporary instruction storage for the VPU. For each VPU task, the CPU(s) 806 may configures the DMA system, optionally prefetch the VPU program into VPU I-cache, and/or kick off each VPU-DMA pair to process a task. The PVA(s) 807 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP 32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 807 to access the system memory independently of the CPU(s) 806. The DMA may support any number of features used to provide optimization to the PVA(s) 807 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 807 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 807, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 807 may be configured to employ data parallelism. For example, in some embodiments, the plurality of vector processors included in a single PVA(s) 807 may execute the same computer vision algorithm, but on different regions of an image. In other examples, the vector processors included in a particular PVA(s) 807 may simultaneously execute different computer vision algorithms, on the same image, or even execute different algorithms on sequential images or portions of an image. Among other things, any number of PVAs 807 may be included in the hardware acceleration cluster and any number of vector processors may be included in each of the PVAs. In addition, the PVA(s) 807 may include additional error correcting code (ECC) memory, to enhance overall system safety.

The accelerator(s) 814 (e.g., the hardware accelerator cluster) have a wide array of uses for autonomous and semi-autonomous machine control. The PVA(s) 807 may be a programmable vision accelerator that may be used for key processing stages in perception, robotics understanding and reasoning, ADAS, semi-autonomous, and autonomous vehicles, etc. The PVA's 807 capabilities are a good match for algorithmic domains needing predictable processing, at low power and low latency. In other words, the PVA(s) 807 performs well on semi-dense or dense regular computation, even on small data sets, which need predictable run-times with low latency and low power. Thus, in the context of platforms for autonomous vehicles and robotics, the PVAs 807 are designed to run classic computer vision algorithms, as they are efficient at object detection and operating on integer math.

For example, according to one embodiment of the technology, the PVA 807 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 807 may perform computer stereo vision function on inputs from two monocular cameras.

In some examples, the PVA(s) 807 may be used to perform dense optical flow. According to process raw RADAR data (e.g., using a 4D Fast Fourier Transform) to provide Processed RADAR. In other examples, the PVA(s) 807 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 807, this is not intended to be limiting. In some embodiments, these components may be included in alternative or additional processing components and/or accelerator(s) 814, and/or may be included as discrete components of the SoC(s) 804 and/or other computing system architecture(s).

In some examples, the SoC(s) 804 may include a real-time ray-tracing hardware accelerator (RTA) 851 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 800 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 851 and/or a ray-tracing optimized GPU 806—such as NVIDIA's RTX GPU.

The accelerator(s) 814 (e.g., in the hardware acceleration cluster) may include one or more optical flow accelerators (OFAs) 811. For example, the OFA(s) 811 may be used for computing optical flow and stereo disparity between frames of sensor data (e.g., images). Optical flow may be accelerated on the OFA(s) 811 for uses such as object detection and tracking, and/or for stereo depth estimation where used for computing stereo disparity between stereo image frames (e.g., two or more frames captured using two or more image sensors with at least partially overlapping fields of view).

The SoC(s) 804 may include one or more camera serial interfaces (CSIs) 823. For example, the CSI(s) 823 may include a mobile industry processor interface (MIPI) camera serial interface (CSI) for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role. For example, the CSI 823 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and implementation.

The accelerator(s) 814 (e.g., the hardware acceleration cluster) may include a computer vision network on-chip (CVNOC) 863 and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by the PVA 807, OFA 811, DLA 809, and/or other accelerator(s) 814. Each pair of memory blocks may include an advanced peripheral bus (APB) interface, configuration circuitry, a controller, and a multiplexer. Any type of memory 815 may be used. The PVA 807, OFA 811, DLA 809, and/or other accelerator(s) 814 may access the memory via a backbone that provides the accelerator(s) 814 with high-speed access to memory. The backbone may include a computer vision network on-chip that interconnects the accelerator(s) 814 to the memory (e.g., using the APB).

The CVNOC 863 may include an interface that determines, before transmission of any control signal/address/data, that the accelerator(s) 814 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 804 may include data store(s) 816 and/or memory 815. The data store(s) 816 may be on-chip memory 815 of the SoC(s) 804, which may store neural networks and/or other algorithms to be executed on the CPU(s) 806, the GPU(s) 808, and/or one or more of the accelerator(s) 814. In some examples, the data store(s) 816 may be large enough in capacity to store multiple instances of neural networks for redundancy and safety. The data store(s) 812 may comprise L2 and/or L3 cache(s) 812, for example. The memory(ies) 815 may include SRAM, LPDDR5, and/or other memory types. For example, the memory(ies) 815 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 816 may include reference to the memory associated with the PVA 807, OFA 811, DLA 809, and/or other accelerator(s) 814, as described herein.

The data store(s) 116 may include various storage types, such as eMMC, NVMe, etc. For example, the SoC(s) 804 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 816 and/or other storage may be accessed via, e.g., NVMe, using PCI Express (PCIe), RDMA, TCP, and/or other protocols.

The SoC(s) 804 may include one or more processor(s) 810 (e.g., embedded processors). The processor(s) 810 may include a boot and power management processor (BPMP) 853, that may be a dedicated processor and subsystem to handle boot power and management functions and related security enforcement. The BPMP 853 may be a part of the SoC(s) 804 boot sequence and may provide runtime power management services. The BPMP 853 may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, accelerator(s) 814, and/or other components. If temperatures are determined to exceed a threshold, BPMP 853 may enter a temperature fault routine and put the SoC(s) 804 into a lower power state and/or put the machine 800 into a chauffeur to safe stop mode (e.g., bring the machine 800 to a safe stop).

The processor(s) 810 may further include a set of embedded processors that may serve as an audio processing engine (APE) 855. The APE 855 may be an audio subsystem that enables full hardware support for multi-channel audio over multiple interfaces, and a broad and flexible range of audio I/O interfaces. In some examples, the APE 855 is a dedicated processor core with a digital signal processor with dedicated RAM.

The processor(s) 810 may further include an always on processor engine (AOPE) 857 that may provide necessary hardware features to support low power sensor management and wake use cases. The AOPE 857 may include a processor core, a tightly coupled RAM, supporting peripherals (e.g., timers and interrupt controllers), various I/O controller peripherals, and routing logic.

The processor(s) 810 may further include a safety processor(s) 813 (alternatively referred to as “safety island 813”), which may include a safety cluster engine that includes a dedicated processor or processor subsystem to handle safety management for automotive, robotics, and/or other applications. The safety processor(s) 813—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 813 may include a discrete processor(s), such that fault of other system components may not impact the performance and availability of the safety processor 813.

The processor(s) 810 may further include a real-time or near real-time sensor engine (SE) 859 that may include a dedicated processor subsystem for handling real-time or near real-time camera, LiDAR, RADAR, and/or other sensor modality management.

The processor(s) 810 may further include one or more image signal processors (ISPs) 827, which may include a high-dynamic range signal processor and/or a hardware engine that is part of one or more sensor processing pipelines.

The processor(s) 810 may include a video image compositor (VIC) 861 that may be a processing block (e.g., implemented on a microprocessor) that implements video post-processing functions needed by a video playback application to produce the final image for the player window. The VIC 861 may perform lens distortion correction on wide-view camera(s) 868B, surround camera(s) 868D, in-cabin monitoring camera sensors, and/or other camera sensors with distorted fields of view.

A VIC 861 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 861 may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a broad range of peripheral interfaces for input/output (I/O) 825, such as to enable communication with peripherals, audio codecs, power management, and/or other devices. The SoC(s) 804 may be used to process data from cameras (e.g., connected over Gigabit Multimedia Serial Link and/or Ethernet), sensors (e.g., LiDAR sensor(s) 864, RADAR sensor(s) 860, etc. that may be connected over Ethernet), data from bus 802 (e.g., speed of machine 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks. In some embodiments, the SoC(s) 804 I/O 825 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 825 elements, components, or features.

The SoC(s) 804 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 804 may include an RJ45 connector with up to 10 GbE, a 1 GbE connector, and/or other networking connector types.

The SoC(s) 104 may include one or more digital signal processors (DSPs) 843. For example, the DSP(s) 843 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 804 may include one or more video encoders 819 and/or one or more video decoders 821. For example, the video encoder(s) 819 may include a hardware-based (e.g., as part of the GPU(s) 808) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 821 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 821 may be hardware-based (e.g., as part of the GPU(s) 808).

The SoC(s) 804 may include one or more general compute acceleration clusters (GCAC(s)) 829. For example, the GCAC(s) 829 may include various processor types that may be used to accelerate compute, such as one or more vector microcode processors (VMPs) 833, one or more multi-threaded processing clusters (MPCs) 831, one or more programmable macro arrays (PMA(s)) 835, and/or one or more other processor types. For example, the GCAC(s) 829 may include a PMA 835, two VMPs 833, and 2 MPCs 831.

The SoC(s) 804 may include one or more vector microcode processors (VMPs) 833. The VMP(s) 833, in embodiments, may include a wide vector (very long instruction word (VLIW) and single instruction multiple data (SIMD)) machine with performing various operations, such as short integral type operations common in computer vision and deep learning algorithms.

The SoC(s) 804 may include one or more multi-threaded processing clusters (MPCs) 831. The MPC(s) 831 may include a processing cluster that be, in embodiments, more versatile than a GPU, and with higher efficiency than a CPU. For example, the MPC(s) 831 may include a multi-threaded processor that allows multiple threads to share resources and execute instructions concurrently.

The SoC(s) 804 may include one or more programmable macro arrays (PMA(s)) 835. The PMA(s) 835 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 804 may include one or more display processing units (DPUs) 845 for performing hardware-accelerated image processing. For example, the DPU(s) 845 may retrieve pixel data from memory 815 and send it to a display peripheral through standard interfaces. As such, the DPU(s) 845 may handle display processing and rendering for in-machine and/or on-machine displays.

The SoC(s) 804 may include one or more application processing units (APUs) 839. For example, the APU(s) 839 may include a quad or dual-core processor with 48 KB/32 KB L1 cache with parity and ECC, along with a 1 MB L2 cache with ECC. The APU(s) 839 may support NEON instructions and single and double precision floating point operations.

The SoC(s) 804 may include one or more real-time processing units (RTPUs) 869. The RTPU(s) 869 may include a dual-core processor with 32 KB/32 KB L1 cache, and 256 KB TCM with ECC. The RTPU(s) 869 may support single and double precision floating point operations.

The SoC(s) 804 may include one or more built-in self-test (BIST) components 837. For example, the BIST component(s) 837 may include memory BIST (MBIST) to test memories of the system and/or logic BIST (LBIST) to test logic of the system. The BIST components 837 may include embedded logic for directly testing logic and/or memory of the system.

The SoC(s) 804 may include one or more dynamically reconfigurable processors (DRPs) 871. For example, the DRP(s) 871 may be used for accelerating various computing operations. For example, the DRP(s) 871 may be combined, in embodiments, with a MAC unit for use as an AI accelerator. In embodiments, the DRP(s) 871 may execute applications while dynamically switching the circuit connection configuration of the arithmetic units (e.g., ALUs) on the chip at each operating clock according to the content to be processed. Since only the necessary arithmetic circuits are used, the DRP(s) 871 may consume less power than with CPU processing and can achieve higher speed. Furthermore, compared to CPUs, where frequent external memory accesses due to cache misses and other causes will degrade performance, the DRP(s) 871 can build the necessary data paths in hardware ahead of time, resulting in less performance degradation and less variation in operating speed (jitter) due to memory accesses. The DRP(s) 871 may include a dynamic loading function that switches the circuit connection information each time the algorithm changes, enabling processing with limited hardware resources, even in robotic/automotive applications that require processing of multiple algorithms.

In some embodiments, the accelerator(s) 814 may include an OpenCV accelerator for speeding up processing of OpenCV, an open-source industry standard library for computer vision processing. In some embodiments, the combination of one or more DRP(s) 871 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 804 may include various compute engines (e.g., processors 810, CPUs 806, GPU(s) 808, accelerator(s) 814, etc.), tasks may be distributed between and among the compute engines, in some instances without common cause failures due to the discrete footprint of the compute engines. Further, because the SoC(s) 804 may include a dedicated safety processor(s) 813 (or safety island 813), critical safety or redundant operations may be performed without common cause failures from the main processing components or compute engines of the SoC(s) 814. Due to these features, the SoC(s) 804 and/or the underlying systems of the machine 800 may be capable of satisfying higher levels of safety—such as automotive safety integrity level (ASIL) D from the ISO 26262 standard.

FIG. 8E is a system diagram for communication between a cloud-based server(s) (e.g., in a data center, such as those described herein) and the example autonomous or semi-autonomous vehicle or machine 800 of FIG. 8A, in accordance with some embodiments of the present disclosure. The system 876 may include a server(s) 878, a network(s) 890, and a machine(s) 800. The server(s) 878 may include a plurality of GPUs 884(A)-884(H) (collectively referred to herein as GPUs 884), switches 882(A)-882(H) (such as PCIe 4.0/5.0/etc switches, M.2 slots, thunderbolt, USB4, NVIDIA's NVLink, NVIDIA's NVSwitch, GPUDirect RDMA, GPUDirect Storage, ultra accelerator Link (UALink), etc.), CPUs 880(A)-880(B) (collectively referred to herein as CPUs 880), accelerators, and/or other processor types. The GPUs 884, the CPUs 880, and the PCIe switches may be interconnected with high-speed interconnects such as, for example and without limitation, NVLink interfaces 888 developed by NVIDIA and/or PCIe connections 886 (and/or ultra accelerator Link (UALink)). In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the machine(s) 800, sensor data indicating information about new or previously unexplored locations, and/or sensor data indicating changes to previously seen/stored locations (e.g., unexpected or changed road conditions, such as recently commenced road-work). The server(s) 878 may transmit, over the network(s) 890 and to the machine(s) 800, neural networks 892, updated neural networks 892, map information 894, etc., including information regarding traffic and road conditions. The updates to the map information 894 may include updates for the HD map 822, SD map, navigation map, etc., such as information regarding construction sites, potholes, detours, flooding, and/or other obstructions. In some examples, the neural networks 892, the updated neural networks 892, the map information 894, and/or the other information may have resulted from new training and/or experiences represented in data received from any number of machine(s) 800 in the environment, and/or based on training performed at a datacenter (e.g., using the server(s) 878 and/or other servers).

The server(s) 878 may be used to train machine learning models (e.g., neural networks) based on training data. The training data may be generated by the machine(s) 800, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 800 (e.g., transmitted to the machine(s) 800 over the network(s) 890, and/or the machine learning models may be used by the server(s) 878 to remotely monitor and/or control the machine(s) 800.

In some examples, the server(s) 878 may receive data from the machine(s) 800 and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the machine 800. For example, the deep-learning infrastructure may receive periodic updates from the machine 800, such as a sequence of images and/or objects that the machine 800 has located in that sequence of images (e.g., via computer vision and/or other machine learning object classification techniques). The deep-learning infrastructure may run its own neural network to identify the objects and compare them with the objects identified by the machine 800 and, if the results do not match and the infrastructure concludes that the AI in the machine 800 is malfunctioning, the server(s) 878 may transmit a signal to the machine 800 instructing a fail-safe computer of the machine 800 to assume control, notify the passengers, and complete a safety maneuver or operation—such as to slow down, hand control back to a driver, come to a stop, and/or pull over/shut down.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### COMPUTING ECOSYSTEM FOR GENERATING, TRAINING, AND DEPLOYING AI

FIG. 9 is a system diagram illustrating a three computer ecosystem 900, including a first computing system 902 for generating or creating artificial intelligence (AI)—such as AI training and validation data, a second computing system 904 for training artificial intelligence, and a third computing system 906 (which may include or correspond to the SoC(s) 804 of FIGS. 8A-8E) deploying the AI at the edge, in accordance with at least some embodiments of the present disclosure. For example, to develop and deploy embodied or physical AI, the three computer ecosystem 900 may be used, including three accelerated computer systems to handle physical AI training, simulation, and runtime (e.g., edge deployment). These systems may generate training data for and train multimodal foundation models (and/or other model types) using scalable, physically based simulations of the machine(s) 800 and their worlds. By doing so, simulation of machine(s) 800 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 800 can perform safely in controlled settings.

The computing system 904 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 800 to understand natural language and emulate movements by observing human actions. The computing system 904 may include a platform that incorporates software, infrastructure, and expertise in a modern, unified AI development and training solution. The computing system 904 may include individual computing devices 910 (e.g., NVIDIA's DGX B200, H200, etc.) and/or any number of computing devices 910 in a data center infrastructure 912 (e.g., NVIDIA's DGX SuperPOD).

For example, the individual computing devices 910 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 910 may include memory (e.g., 4 TB memory, and storage (e.g., OS storage of 2×1.9 TB NVMe M.2, and internal storage of 8×3.84 TB NVMe U.2). The computing devices 910 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 910 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 910 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 910 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 910 may include a smart host channel adapter (HCA) (e.g., NVIDIA's ConnectX-7) to provide ultra-low latency, 400 Gb/s throughput for in-network computing acceleration engines.

The data center infrastructure 912 may include any number of the computing devices 910, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 910) to thousands, job scheduling and orchestration to ensure hassle-free execution of every developer's job, AI workflow management and machine learning operations (MLOps) to move more models from prototype to production, and enterprise software to speed developer success.

The computing system 902 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 902 allows developers to use simulation frameworks to simulate and validate robot models, and/or to generate massive amounts of physically-based synthetic data to bootstrap model training. The computing system 902 may support learning frameworks that power robot reinforcement learning and imitation learning, to accelerate robot policy training and refinement. For example, the computing system 902 may be used to generate any number of simulations 908—such as within NVIDIA's OMNIVERSE. The computing system 902 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 902 may host or support a native OpenUSD software platform enabling enterprises to connect 3D pipelines and develop advanced, real-time 3D applications for industrial digitalization. With powerful ray-tracing-accelerated AI and graphics capabilities, the computing system 902 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 902 may include individual computing devices 914 (e.g., NVIDIA's OVX L40S Server) and/or any number of computing devices 914 in a data center infrastructure 916 (e.g., NVIDIA's OVX Systems).

The computing device(s) 914 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16: 64 GB/s bidirectional interconnect interface, 18,176 CUDA cores, 142 ray tracing (RT) cores, and 568 tensor cores). The computing devices 914 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 914 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 914 may include a smart host channel adapter (HCA) (e.g., NVIDIA's ConnectX-7) to provide ultra-low latency, 400 Gb/s throughput for in-network computing acceleration engines. The computing device(s) 914 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 912, the data center infrastructure 916 may allow for any number of computing device(s) 914 to be combined in cluster configuration according to a reference architecture.

The computing system 906 may be used to deploy trained AI models on a runtime computer—such as the SoC(s) 804 described herein. For example, these computing systems 906 may be designed for compact, on-board computing needs, including an ensemble of models for control policy, vision and language models, etc., deployed on a power-efficient on-board edge computing system 906. Details of components, features, and capabilities of the computing system 906 may be described in more detail herein with respect to FIGS. 8A-8E.

### EXAMPLE GENERATIVE MODELS

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10 is a block diagram of an example generative language model system 1000 suitable for use in implementing at least some embodiments of the present disclosure. In the example illustrated in FIG. 10, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a MMLM, a VLA model, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization (TN), for example, by converting all characters to lowercase, removing accents, and/or or handling special cases like contractions or abbreviations to ensure consistency (e.g., converting ¼ to one quarter). Similarly, the input processor 1005 and/or a post-processor may perform inverse text normalization (ITN) in order to convert plain language back to canonical or other forms (e.g., to convert one quarter to ¼) . These are just a few examples, and other types of input and/or output processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink or ultra accelerator Link (UALink) Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### EXAMPLE COMPUTING DEVICE

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s), speaker(s), etc.), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLink, ultra accelerator Link (UALink), etc.) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

Clause 1. One or more processors comprising processing circuitry to determine, from sensor data generated using at least one sensor of an ego-machine in an environment, first data representing the environment.
Clause 2. The one or more processors of clause 1, wherein the processing circuitry is further to generate, using one or more Neural Networks (NNs) and based at least on the first data, a set of extracted features.
Clause 3. The one or more processors of clause 1 or 2, wherein the processing circuitry is further to generate, for at least one individual anchor of one or more linear or curved anchors, a set of sampled features based at least on sampling from the set of extracted features at locations associated with the at least one individual anchor.
Clause 4. The one or more processors of clause 1, 2 or 3, wherein the processing circuitry is further to generate, using the one or more NNs and based at least on the set of sampled features for the at least one individual anchor of the one or more linear or curved anchors, second data representing at least one regressed line corresponding to at least one detected surface feature.
Clause 5. The one or more processors of clause 1, 2, 3 or 4, wherein the processing circuitry is further to cause performance of one or more planning, control, or navigation operations associated with the ego-machine based on the second data.
Clause 6. The one or more processors of clause 1, 2, 3, 4 or 5, wherein the sampling from the set of extracted features is at a designated longitudinal interval along the at least one individual anchor.
Clause 7. The one or more processors of clause 1, 2, 3, 4 or 5, wherein the sampling from the set of extracted features is at one or more deformable offsets from the at least one individual anchor of the one or more linear or curved anchors.
Clause 8. The one or more processors of clause 1, 2, 3, 4 or 5, wherein the first data represents a top-down view of the environment, and at least one of the one or more linear or curved anchors is slanted relative to the top-down view.
Clause 9. The one or more processors of clause 1, 2, 3, 4 or 5, wherein the processing circuitry is further to generate the second data based at least on processing the set of sampled features, sampled at the locations associated with the at least one individual anchor, using a corresponding number of interacting branches of the one or NNs.
Clause 10. The one or more processors of clause 1, 2, 3, 4 or 5, wherein the second data further comprises one or more classifications of visibility of at least one individual point of one or more points on the regressed line corresponding to the at least one individual anchor.
Clause 11. The one or more processors of clause 1, 2, 3, 4 or 5, wherein the second data further comprises regression uncertainty of one or more regressed values representing at least one individual point of one or more points on the regressed line corresponding to the at least one individual anchor.
Clause 12. The one or more processors of clause 1, 2, 3, 4 or 5, wherein the second data further comprises one or more classifications indicating whether at least one individual point of one or more points on the regressed line corresponding to the at least one individual anchor belong to a left rail or a right rail of a lane.
Clause 13. The one or more processors of clause 1, 2, 3, 4 or 5, wherein the processing circuitry is further to generate the second data representing at least one regressed line based at least on one or more refinement stages of the one or more NNs that predict one or more lateral offsets relative to one or more initially predicted lateral offsets from the at least one individual anchor.
Clause 14. The one or more processors of clause 1, 2, 3, 4 or 5, wherein the one or more NNs are trained based at least on training data comprising one or more ground truth surface features associated with one or more corresponding anchors of the one or more linear or curved anchors based at least on summed distance between the one or more ground truth surface features and a set of sampled points on the one or more corresponding anchors.
Clause 15. The one or more processors of clause 1, 2, 3, 4 or 5, wherein the ego-machine includes an autonomous machine, a semi-autonomous machine, a robot, a drone, a watercraft, or a warehouse vehicle.
Clause 16. The one or more processors of clause 1, 2, 3, 4 or 5, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
Clause 17. A method comprising generating, for at least one individual anchor of one or more linear or curved anchors, a set of sampled features, the set of sampled features generated based at least on sampling from a set of extracted features at locations associated with the at least one individual anchor.
Clause 18. The method of clause 17, further comprising generating, using one or more Neural Network (NNs) and based at least on the set of sampled features for the at least one individual anchor of the one or more linear or curved anchors, a representation of at least one regressed line corresponding to at least one detected surface feature.
Clause 19. The method of clause 17 or 18, further comprising generating the representation of the at least one regressed line based at least on one or more refinement stages of the one or more NNs that predict one or more lateral offsets relative to one or more initially predicted lateral offsets from the at least one individual anchor.
Clause 20. The method of clause 17 or 18, wherein the method is performed by at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
Clause 21. An autonomous or semi-autonomous machine comprising one or more systems-on-a-chip (SoCs) individually comprising one or more central processing units (CPUs), one or more graphics processing units (GPUs), and one or more hardware accelerators, and one or more sensors having fields of view or sensory fields external to the autonomous or semi-autonomous machine, wherein the one or more SoCs are to cause the autonomous or semi-autonomous machine to navigate based at least on one or more surface features, the one or more surface features detected based at least on one or more anchor-wise passes that process, through at least a portion of one or more Neural Network (NNs), a sampled set of extracted features sampled at locations associated one or more individual anchors of one or more linear or curved anchors.
Clause 22. The autonomous or semi-autonomous of clause 21, wherein a single SoC of the one or more SoCs is capable of 275 tera operations per second (TOPS) of AI performance.
Clause 23. The autonomous or semi-autonomous of clause 21, wherein the one or more hardware accelerators include at least one of a vision accelerator, a ray-tracing accelerator, an optical flow accelerator, or a deep learning accelerator.
Clause 24. The autonomous or semi-autonomous of clause 21, wherein the autonomous or semi-autonomous machine includes a vehicle, a car, a truck, a robot, a humanoid robot, an autonomous mobile robot (AMR), a warehouse vehicle, a drone, a watercraft, or an aircraft.
Clause 24. The autonomous or semi-autonomous machine of clause 21, wherein the autonomous or semi-autonomous machine includes or uses at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
determine, from sensor data generated using at least one sensor of an ego-machine in an environment, first data representing the environment;
generate, using one or more Neural Networks (NNs) and based at least on the first data, a set of extracted features;
generate, for at least one individual anchor of one or more linear or curved anchors, a set of sampled features based at least on sampling from the set of extracted features at locations associated with the at least one individual anchor;
generate, using the one or more NNs and based at least on the set of sampled features for the at least one individual anchor of the one or more linear or curved anchors, second data representing at least one regressed line corresponding to at least one detected surface feature; and
cause performance of one or more planning, control, or navigation operations associated with the ego-machine based on the second data.

2. The one or more processors of claim 1, wherein the sampling from the set of extracted features is at a designated longitudinal interval along the at least one individual anchor.

3. The one or more processors of claim 1, wherein the sampling from the set of extracted features is at one or more deformable offsets from the at least one individual anchor of the one or more linear or curved anchors.

4. The one or more processors of claim 1, wherein the first data represents a top-down view of the environment, and at least one of the one or more linear or curved anchors is slanted relative to the top-down view.

5. The one or more processors of claim 1, wherein the processing circuitry is further to generate the second data based at least on processing the set of sampled features, sampled at the locations associated with the at least one individual anchor, using a corresponding number of interacting branches of the one or NNs.

6. The one or more processors of claim 1, wherein the second data further comprises one or more classifications of visibility of at least one individual point of one or more points on the regressed line corresponding to the at least one individual anchor.

7. The one or more processors of claim 1, wherein the second data further comprises regression uncertainty of one or more regressed values representing at least one individual point of one or more points on the regressed line corresponding to the at least one individual anchor.

8. The one or more processors of claim 1, wherein the second data further comprises one or more classifications indicating whether at least one individual point of one or more points on the regressed line corresponding to the at least one individual anchor belong to a left rail or a right rail of a lane.

9. The one or more processors of claim 1, wherein the processing circuitry is further to generate the second data representing at least one regressed line based at least on one or more refinement stages of the one or more NNs that predict one or more lateral offsets relative to one or more initially predicted lateral offsets from the at least one individual anchor.

10. The one or more processors of claim 1, wherein the one or more NNs are trained based at least on training data comprising one or more ground truth surface features associated with one or more corresponding anchors of the one or more linear or curved anchors based at least on summed distance between the one or more ground truth surface features and a set of sampled points on the one or more corresponding anchors.

11. The one or more processors of claim 1, wherein the ego-machine includes an autonomous machine, a semi-autonomous machine, a robot, a drone, a watercraft, or a warehouse vehicle.

12. The one or more processors of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

13. A method comprising:
generating, for at least one individual anchor of one or more linear or curved anchors, a set of sampled features, the set of sampled features generated based at least on sampling from a set of extracted features at locations associated with the at least one individual anchor; and
generating, using one or more Neural Network (NNs) and based at least on the set of sampled features for the at least one individual anchor of the one or more linear or curved anchors, a representation of at least one regressed line corresponding to at least one detected surface feature.

14. The method of claim 13, further comprising generating the representation of the at least one regressed line based at least on one or more refinement stages of the one or more NNs that predict one or more lateral offsets relative to one or more initially predicted lateral offsets from the at least one individual anchor.

15. The method of claim 13, wherein the method is performed by at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

16. An autonomous or semi-autonomous machine comprising:
one or more systems-on-a-chip (SoCs) individually comprising one or more central processing units (CPUs), one or more graphics processing units (GPUs), and one or more hardware accelerators; and
one or more sensors having fields of view or sensory fields external to the autonomous or semi-autonomous machine,
wherein the one or more SoCs are to cause the autonomous or semi-autonomous machine to navigate based at least on one or more surface features, the one or more surface features detected based at least on one or more anchor-wise passes that process, through at least a portion of one or more Neural Network (NNs), a sampled set of extracted features sampled at locations associated one or more individual anchors of one or more linear or curved anchors.

17. The autonomous or semi-autonomous of claim 16, wherein a single SoC of the one or more SoCs is capable of 275 tera operations per second (TOPS) of AI performance.

18. The autonomous or semi-autonomous of claim 16, wherein the one or more hardware accelerators include at least one of a vision accelerator, a ray-tracing accelerator, an optical flow accelerator, or a deep learning accelerator.

19. The autonomous or semi-autonomous of claim 16, wherein the autonomous or semi-autonomous machine includes a vehicle, a car, a truck, a robot, a humanoid robot, an autonomous mobile robot (AMR), a warehouse vehicle, a drone, a watercraft, or an aircraft.

20. The autonomous or semi-autonomous machine of claim 16, wherein the autonomous or semi-autonomous machine includes or uses at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
